(19) United States
(12) Patent Application Publication
(10) Pub. No.: US 2003/0229524 A1
(43) Pub. Date: Dec. 11, 2003

(54) System for workflow analysis and response

(76) Inventor: Eran Reuveni, Tel-Aviv (IL)

Correspondence Address: MORTON CHIRNOMAS & ASSOC., 11355 W. OLYMPIC BLVD., SUITE 100, LOS ANGELES, CA, 90064, US

(21) Appl. No.: 09/782,349

(22) Filed: Feb. 12, 2001

Related U.S. Application Data
(60) Provisional application No. 60/208,876, filed on Jun. 1, 2000.

(51) Int. Cl. G06F 17/60

(52) U.S. Cl. 705/7; 705/11

(57) ABSTRACT

The system for workflow analysis and response performs labor studies and operations research in cross-platform systems involving software usage and electronic data interchange. The workflow system is able to integrate built-in tools of the respective platform components, and facilitate the implementation of analysis add-on packages and interfaces as they are developed.

The workflow system provides users with workflow records and processed displays and reports. The system provides a variety of Gantt chart reports to summarize work activity. Management sets parameters for notification when limits are exceeded. Analysis and response are performed in real-time and interactively.

### FIELD OF THE INVENTION

The present invention relates generally to software-based systems, and specifically to software for performing labor studies and operations research in working environments where most of the workflow is carried out as software usage and electronic data interchange.

### BACKGROUND OF THE INVENTION

Manual time measurement, the existing method for performing labor studies and operations research, is not suitable for the environments of computer software usage and electronic data interchange, as it calls for very close examination by, and a lot of attention from, the person conducting the measurements, in order to closely determine the screen usage statistics of the computer system. On the other hand, attempting to rely on data collected by the software being used has its own drawbacks, and is useful only as long as the persons being monitored use only one type of system (or resource), but often workflow progresses through a multi-platform environment, and integrating the different sources of workflow information calls for substantial manual effort.

A commercial, cross-platform workflow data source is not known, and therefore, neither is any software package designed to analyze such data.

Usually, workflow analysis applications may be performed in one of two ways:

(a) by being a part of the system which provides the workflow design and resulting business applications, providing workflow analysis as a byproduct; or:

(b) by being a part of a general purpose expert system, which after proper mapping of the different data sources into its own database, could perform analysis with its own expert-system capabilities.

A common course of action, when a comprehensive display of complex workflows is needed, is to produce analysis reports for purposes of resource planning, re-engineering etc. Specialized consultants are hired to conduct a research project, collect and analyze information manually and expensively, and turn out a summary report. A major drawback of this method is that it is a one-time effort, producing historical data. In many cases, by the time such a report reaches its intended users, it has already become obsolete.

### SUMMARY OF THE INVENTION

Accordingly, it is a principal object of the present invention to overcome the limitations of existing workflow analysis and response systems and to provide improved methods and apparatus for implementing measurement systems.

It is a further object of some aspects of the present invention to provide improved methods and apparatus for cross-platform labor and resource analysis measurement systems.

It is a still further object of some aspects of the present invention to provide improved methods and apparatus for implementation of built-in workflow analysis and response measurement tools available within the systems being analyzed, thus making full use of the data collected.

It is yet a still further object of some aspects of the present invention to provide improved methods and apparatus permitting the establishment of an infrastructure for the implementation of analysis add-on packages and interfaces as they are developed.

A method for processing user resources, including the steps of:

receiving the said user resources on a user multi-platform computer system;

monitoring the workflow;

automatically analyzing the processing of said resources to gather information, measure the results and respond to the workflow; and

outputting decision-support data.

Apparatus for processing user resources residing on a multi-platform system, which product includes:

a system server to provide access to the required information;

a system database for the storage of the said information required for the said system;

a system administrator to edit information required for the operation of the said system; and

a system consultant for advanced analysis of historical data.

The workflow analysis and response system provides users with workflow records and processed displays and reports, while minimizing manual work and integration effort. Only an initial one-time expenditure of programming resources is required for the creation of appropriate code in the corporate information systems, or similar, joining together the corporate systems and the analysis system. This can be done by loading and using the system server interface from within specified Intervention Points inside the corporate system source code or scripting (customization) code. Furthermore, a unique feature of the analysis system is the way in which different elements, (including software engineering technologies, industrial engineering methodologies and mathematical concepts) are brought together to produce outputs which were either previously unobtainable or obtainable at a much higher effort and cost, and in a way which restricted their usefulness. In general, the programming tools provide the input to the system and the management tools provide its output. The abovementioned elements, their mode of functioning, and their outputs, are described hereinbelow.

Hereinafter, the term “classification” refers to an attribute of operation, used to describe its outcome, sub-type or any other categorization. A classification is selected from a list of allowed classification types.

Hereinafter, the term “event” refers to a meaningful point in time during the progress of an operation, whose event type describes that meaning. Several events may be recorded during a single operation.

Hereinafter, the term “operation” refers to a part of a work process, carried out by a specific user, characterized by an operation type.

Hereinafter, the term “state” refers to an attribute of operation, used to describe its current stage, status, or completion level. A state is selected from a specific state set.

Hereinafter, the term “state set” refers to a list of possible states through which an operation proceeds.

Hereinafter, the term “tag” refers to an attribute of operation, used to store any user-defined information string.

Hereinafter, the term “type” refers to a predefined description of operation, classification or event, consisting of a unique numerical index, a unique string key, and a descriptive name.

Hereinafter, the term “user” refers to a specific person selected from a fixed list of known users, carrying out an operation. A user may carry out several operations simultaneously.

Hereinafter, the term “agent” refers to an employee being monitored by the workflow system.

Hereinafter, the term “rule” refers to the definition of a reaction taken when a certain condition occurs.

Hereinafter, the term “library” refers to a collection of related rules.

The analysis system is a software package serving specifically as a workflow analysis and response system, and provides development tools for programmers. The analysis system can be integrated with existing business applications. It then counts, sorts and measures times of activities and events related to the usage of these applications by the business applications users. The system provides programmers with the interfaces necessary to embed the system “engine” within corporate or other information systems. The interfaces implemented, either in the development stage of new applications, or during integration with existing software, through customization tools such as VBA sold by Microsoft, or VB Script licensed by Microsoft.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of the workflow control and analysis system, in accordance with a preferred embodiment of the present invention;

FIG. 2 is a schematic illustration of the operational tables and their interaction with the actual workflow, in accordance with a preferred embodiment of the present invention;

FIG. 3 is a schematic illustration of the functions of the system model, in accordance with a preferred embodiment of the present invention;

FIG. 4 is a schematic illustration of how the system administrator participates in system operation, in accordance with a preferred embodiment of the present invention;

FIG. 5 is a flow chart that schematically illustrates how the system organizes the security interactions, in accordance with a preferred embodiment of the present invention;

FIG. 6 is a schematic illustration of the functions of the system supervisor, in accordance with a preferred embodiment of the present invention;

FIG. 7 is a schematic illustration of the functions of the system reactor, in accordance with a preferred embodiment of the present invention;

FIG. 8 is a computer screen image of a dialog box illustrating the reactor dialog, in accordance with a preferred embodiment of the present invention;

FIG. 9 is a computer screen image illustrating the creation of a time-dependent “event,” in accordance with a preferred embodiment of the present invention;

FIG. 10 is a computer screen image illustrating a notice message, in accordance with a preferred embodiment of the present invention;

FIG. 11 is a flow chart that schematically illustrates how the function of the callflow analyzer, in accordance with a preferred embodiment of the present invention;

FIG. 12 is a graph that schematically illustrates the function of a Gantt chart, in accordance with the prior art;

FIG. 13 is a schematic illustration of the functions of the callflow analyzer, in accordance with a preferred embodiment of the present invention;

FIG. 14 is a computer screen image illustrating the main window of the CFA user interface, in accordance with a preferred embodiment of the present invention;

FIG. 15 is a computer screen image illustrating the “roll” and “filter” features of the main window of the CFA user interface, in accordance with a preferred embodiment of the present invention.

FIG. 16 is a set of computer screen images illustrating the full sub-windows of the CFA user interface, in accordance with a preferred embodiment of the present invention.

### DETAILED DESCRIPTION OF PREFERRED EMBODIMENTS

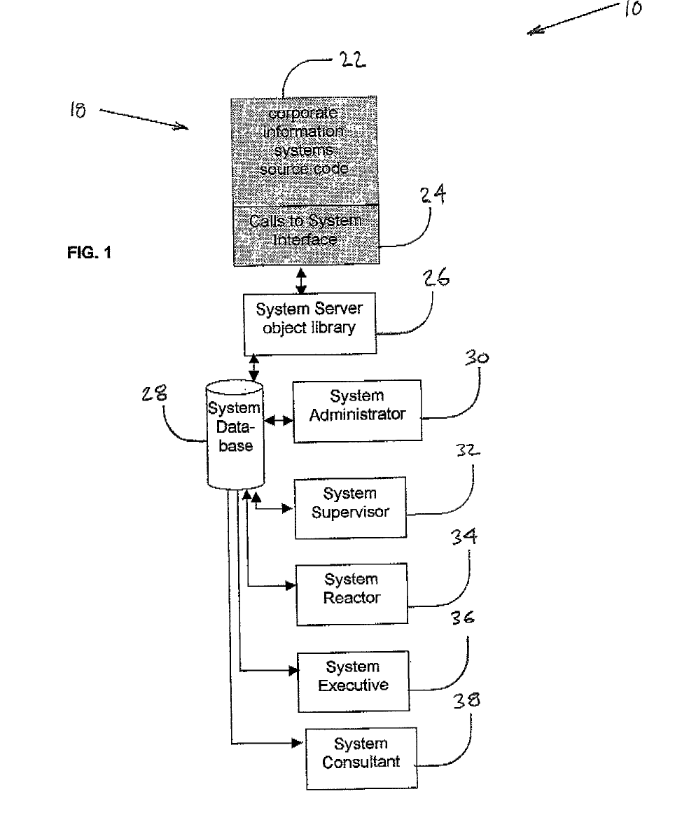

Reference is now made to FIG. 1, which illustrates the workflow control and analysis system 10, in accordance with a preferred embodiment of the present invention. A computer 18 stores the corporate information systems source code 22 and a communications module 24 to initiate calls to the systems interface. Mainframe 18 interacts with the system components through a system server object library 26. The system 10 provides supervisory users with the following components stored on the system database 28:

a “System Administrator” 30 for setting up initial workflow parameters, users and security;

a “System Supervisor” 32 for producing real-time workflow monitoring screens;

a “System Reactor” 34 for defining and activating alert and response rules;

a “System Executive” 36 for creating and distributing analysis reports; and

a “System Consultant” 38 for advanced analysis of historical data.

Database 28 includes various kinds of tables. “Operational tables” concern the actual workflow information. By contrast, “administrative tables” contain information regarding security, system information, etc.

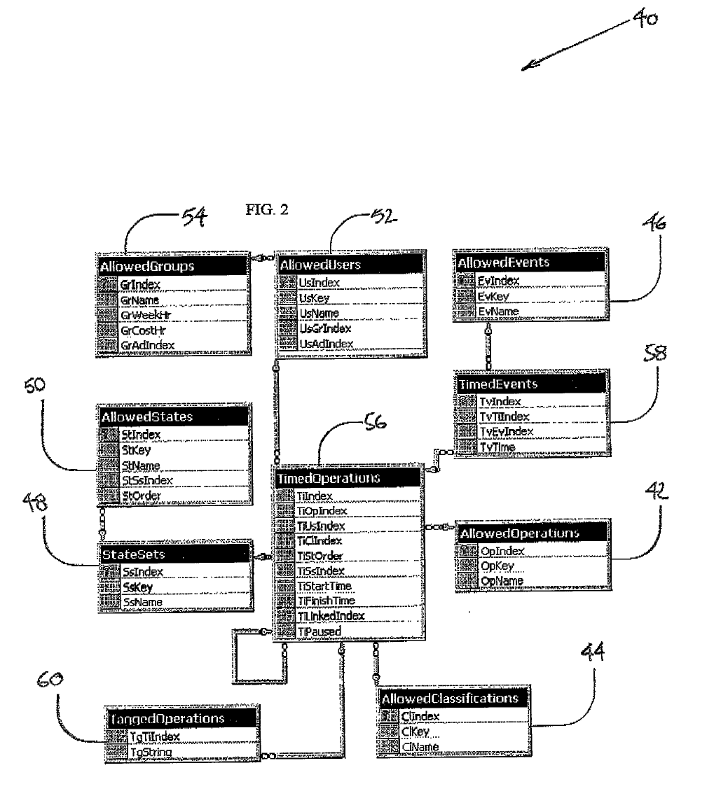

FIG. 2 is a schematic illustration of the operational tables 40 and their interaction with the actual work flow, in accordance with a preferred embodiment of the present invention. Operational tables 40 interact with the actual workflow information, as opposed to the “administrative tables”, which contain information regarding security, system information etc., as described hereinbelow. Table I illustrates the details of some of the operational tables.

TABLE I

| Table | FieldName | Description | Type |
|---|---|---|---|
| AllowedOperations | Opindex | Operation Identifier Index | integer |
| 42 | OpKey | Operation Applicative Key | string |
| | OpName | Operation Descriptive Name | string |
| AllowedClassifica-tions | ClIndex | Classification Identifier Index | integer |
| 44 | ClKey | Classification Applicative Key | string |
| | ClName | Classification Descriptive Name | string |
| AllowedEvents 46 | EvIndex | Event Identifier Index | integer |
| | EvKey | Event Applicative Key | string |
| | EvName | Event Descriptive Name | string |
| StateSets 48 | SsIndex | State Set Identifier Index | integer |
| | SsKey | State Set Applicative Key | string |
| | SsName | State Desriptive Name | string |
| AllowedStates 50 | StIndex | State Identifier Index | integer |
| | StKey | State Applicative Key | string |
| | StName | State Descriptive Name string | string |
| | StSsIndex | State Set Index | integer |
| | StOrder | State Order In Set | integer |
| AllowedUsers 52 | UsIndex | User Identifier Index | integer |
| | UsKey | User Applicative Key | string |
| | UsName | User Name | string |
| | UsGrIndex | User Group Index | integer |
| AllowedGroups 54 | GrIndex | Group Identifier Index | integer |
| | GrName | Group Descriptive Name | string |
| | GrWeekHr | Group Work Hours per Week | byte |
| | GrCostHr | Group Cost per Hour | integer |
| TimedOperations 56 | TiIndex | Timer Identifier Index | long |
| | TiOpIndex | Timer Operation Index | integer |
| | TiUsIndex | Timer User Index | integer |
| | TiClIndex | Timer Classification Index | integer |
| | TiStOrder | Time State Order in Set | integer |
| | TiSsIndex | Timer State Set Index | string |
| | TiStart | Timer Starting Time date | time |
| | Time | | |
| | TiFinish | Timer Finishing Time date | time |
| | Time | | |
| | TiLinked | Timer Linked Record Index | long |
| | Index | | |
| | TiPaused | Timer is Paused | bit |
| TimedEvents 58 | TvIndex | Timed Event Identifier Index | long |
| | TvTiIndex | Timed Event Timer Index | long |
| | TvEvIndex | Timed Event Event Index | integer |
| | TvTime | Timed Event Occurance Time date | time |
| TaggedOperations 60 | TgTiIndex | Tag Timer Index | long |
| | TgString | Tag String | string |

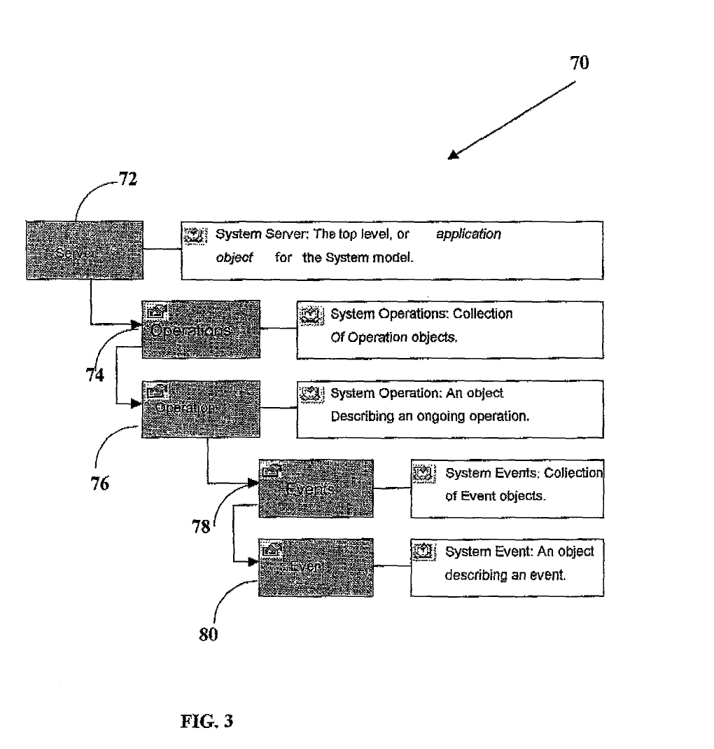

FIG. 3 is a schematic illustration of the functions of the system model 70, in accordance with a preferred embodiment of the present invention. The system server 72 uses a hierarchy of classes, which together form a COM library called “SYSTEMLib”. System server 72 contains a set of objects which perform the actual workflow data collection. These objects can be manipulated by programmers through a Component Object Modeling (COM) interface, from within any instruction code set that recognizes COM. The entire functionality of system server 72 is available to the programmer/user through the classes of the SYSTEMLib library.

The main function of system server 72 is to provide system information, as well as access to, or initiation of, lower level objects. SyOperations 74 and SyOperation 76 are where most activity occurs, i.e., where ongoing operations, which have started in the current session, are stored.

The low level objects, SyEvents 78 and SyEvent, 80 store information regarding events, which have occurred during ongoing operations. Each member of SyOperations, e.g., those related to a specific ongoing operation, provides access to SyEvents containing events related to that operation.

The classes of system server 72 are sorted in a generally descending order according the hierarchy of FIG. 3:

system server 72;

system operations 74;

system operation 76;

system events 78; and

system event 80.

Members within a class are sorted alphabetically.

Table II is a set of seven sub-tables, TABLE IIA through TABLE IIG, illustrating the details of the hierarchy of system server classes.

TABLES II
Preferred system server class: TABLE IIA

| | |
|---|---|
| [symbol] ClassificationKeys | A SyAllowedClassifications collection of allowed |
| | classification codes. |
| [symbol] ContinueOperation (Index) | Adds to Operations an operation previously paused. |
| | Returns new SyOperation. |
| [symbol] EventKeys | A SyAllowedEvents collection of allowed event keys. |
| [symbol] OperationKeys | A SyAllowedOperations collection of allowed |
| | operation keys. |
| [symbol] Operations | Collection of ongoing SyOperations. |
| [symbol] StartOperation(OpKey, | Adds a new Operation to Operations. Returns new |
| [UsKey], [StateSet, | SyOperation. |
| [InitialState]]) | |
| [symbol] StateSetKeys | A SyAllowedStateSets collection of allowed state |
| | Keys. |
| [symbol] Time | Returns server clock time. |
| [symbol] CheckVersion (Major, Minor) | Returns true if current System version is compliant |
| | with the version specified. |

Preferred system server operations class: TABLE IIB

| | |
|---|---|
| [symbol] Count( ) | Returns number of ongoing |
| | Operations. |
| [symbol] FindOperation(Index) | Returns Operation by TimedOperations index. |
| [symbol] Item(Index) | Returns an Operation from the collection. |
| [symbol] PauseUser(UsKey) | Pauses all of user's ongoing operations. |
| [symbol] StopUser(UsKey) | Stops all of user's ongoing operations. |

Preferred system server operation class: TABLE IIC

| | |
|---|---|
| [symbol] AddEvent(EvKey) | Adds a new Event to Events. Returns new SyEvent. |
| [symbol] Chain (OpKey, StateSet, | Stops current operation and Starts a new one, linking |
| [InitialState]]) | the two. Returns new SyOperation. |
| [symbol] Classification | Set/returns Classification key. |
| [symbol] Events | A collection of Event objects for operation. |
| [symbol] Index | Returns ongoing operation index. |
| [symbol] NextState( ) | Increases state by 1. Returns state prior to change. |
| [symbol] OperationKey | Returns Operation key identifier. |
| [symbol] Pause( ) | Removes operation from Operations, without |
| | marking a finishing time. |
| [symbol] PreviousState( ) | Decreases state by 1. Returns state prior to change. |
| [symbol] StartedTime | Returns starting time. |
| [symbol] State | Sets/returns State key. |
| [symbol] StateSet | Returns State Set Key. |
| [symbol] Stop( ) | Removes operation from Operations, marking its |
| | finishing time. |
| [symbol] Tag | Sets/returns Operation tag. |
| [symbol] UserKey | Returns User Key identifier. |

Preferred system server events class: TABLE IID

| | |
|---|---|
| [symbol] Count( ) | Returns number of events. |
| [symbol] Item(Index) | Returns an Event from the collection. |

Preferred system server event class: TABLE IIE

| | |
|---|---|
| [symbol] Index | Returns Index. |
| [symbol] Key | Returns Event Key. |
| [symbol] Time | Returns Time of event. |

System key collection classes: SyAllowedEvents, SyAllowedClassifications,
SyAllowedStateSets, SyAllowedOperations: TABLE IIF

| | |
|---|---|
| [symbol] Count( ) | Returns number of items. |
| [symbol] Item(Index) | Returns item of matching index. |

System key item classes: SyAllowedEvent, SyAllowedClassification,
SyAllowedStateSet, SyAllowedOperation: TABLE IIG

| | |
|---|---|
| [symbol] Index | Index number of item. |
| [symbol] Key | Key string of item. |
| [symbol] Name | Full name string of item. |

Normally, operation's attributes are not set as free-text values (with the exception of the Tag). Rather, the operation's type, user, classification, state, event types etc. are selected from lists of “allowed values”, such as AllowedOperations, AllowedUsers, and so on.

This selection may be done directly using an allowed key that is known to the programmer, for instance:

MYOPERATION.CLASSIFICATION=“SUCCESSFUL”

or via the key item classes, for instance:

MYOPERATION.CLASSIFICATION=SYSERVER.ALLOWEDCLASSIFICATIONS. ITEM(CLNUMBE R). KEY

The System Administrator

System administrator 30 edits information required for the operation of system 16. This includes mainly user authorizations and workflow parameters. User permissions are defined using a scheme described hereinbelow. According to this scheme, each system “document” (i.e. an “Executive” report, a “Supervisor” online screen etc.) can be assigned to a group and/or security level. Only then is the document accessible by users with appropriate security level and group designation on the specific application (“Executive”, “Supervisor” etc.). The same scheme is applied for non document-specific permissions, such as logging in into an application.

The workflow parameters tables 92 contain most of the information included in the “operational tables”, described hereinabove (system database 28), with the exception of TimedOperations, TaggedOperations and TimedEvents, which record actual workflow execution 94 and are automatically created by system server 26.

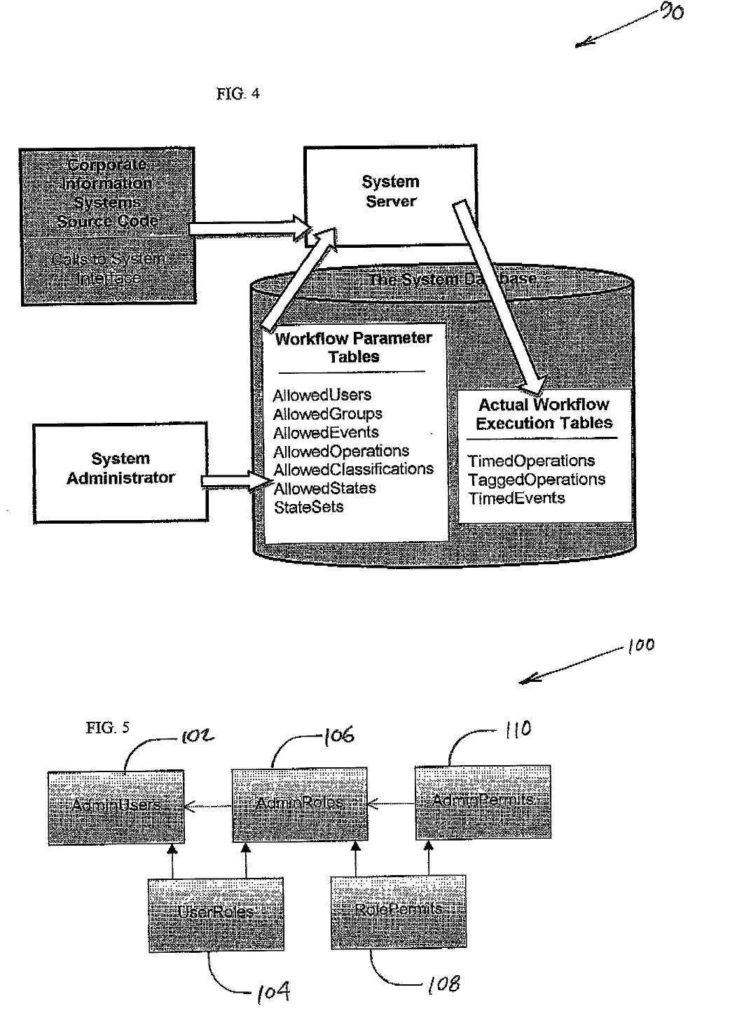

FIG. 4 is a schematic illustration of how system administrator 30 participates in system operation 90, in accordance with a preferred embodiment of the present invention.

The Preferred System Security Scheme

FIG. 5 is a flow chart that schematically illustrates how the system organizes the security interactions 100, in accordance with a preferred embodiment of the present invention.

Table III illustrates the details of the of the security parameters corresponding to the table elements of FIG. 5.

TABLE III

| Table Elements | Field Name | Description | Type |
|---|---|---|---|
| AdminUsers | AdIndex | Administrative User Index | integer |
| 102 | AdName | Administrative User Name | string |
| | AdPassword | Administrative User Password | string |
| | AdMachine | Administrative User MSMQ Site | string |
| | AdMail | Administrative User E-Mail | string |
| UserRoles | UrAdIndex | Administrative User Index | integer |
| 104 | UrArIndex | Administrative Role Index | integer |
| AdminRoles | ArIndex | Administrative Role Index | integer |
| 106 | Name | Administrative Role Name | string |
| RolePermits | RpArIndex | Administrative Role Index | integer |
| 108 | RpApIndex | Administrative Permit Index | integer |
| AdminPermits | ApIndex | Administrative Permit Index | integer |
| 110 | ApName | Administrative Permit Name | string |
| | ApApp | Administrative Permit | string |
| | | Application | |

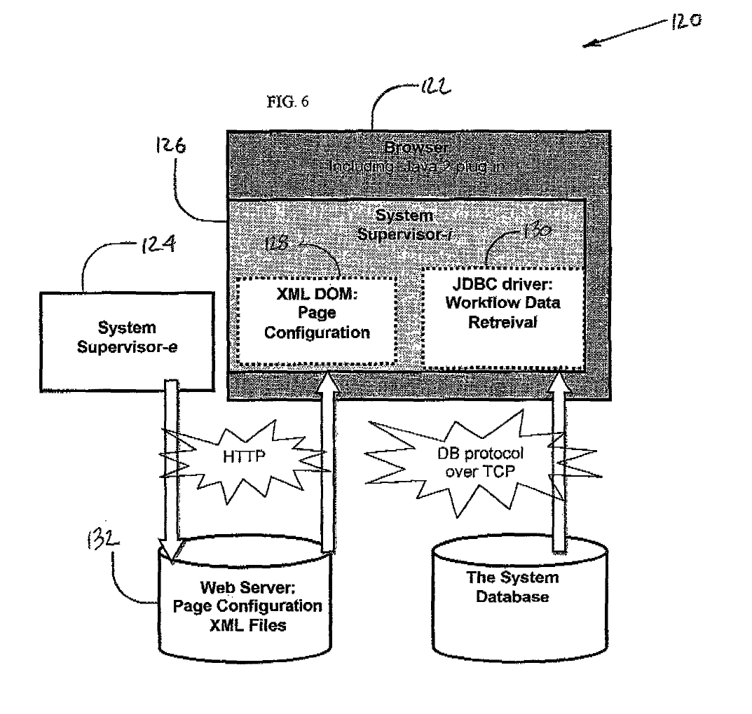

FIG. 6 is a schematic illustration of the system supervisor functions 120, in accordance with a preferred embodiment of the present invention.

The System Supervisor

The system supervisor 32 is a monitoring tool designed to enable authorized personnel to watch online workflow information using a web (Internet/intranet) browser 122. System supervisor 32 is in essence a set of two separate applications:

The System Supervisor-e 124 is the editor, with which online pages are created and configured; and:

The System Supervisor-i 126 is a viewer, an applet which is run on browser 122 and with which pages are viewed and populated with online data.

Supervisor-i 126 components have a cross-platform capability, so that system 16 online data pages can be displayed from any operating system. This is achieved by putting together a wide range of available software technologies, the most notable of which are Java licensed by Sun, the Java DataBase Connectivity (JDBC) licensed by Sun and Extensible Markup Language (XML) supported by Microsoft and other vendors. XML Document Object Module (DOM) 128 is a specification for application program interfaces for accessing the content of XML documents. DOM is used because it provides the expected format for relational, hierarchical and non-symmetric data representation. Java programming language, being robust, secure, and automatically downloadable on a network, is an optimal basis for cross-platform database applications. JDBC driver 130 is the mechanism for talking from Java to remote data sources.

Supervisor-i Data Flow.

The Supervisor-i Java applet is preferably loaded into a client browser in this preferred embodiment invoking suitable components such as Swing Java components (licensed from Sun). This process may require the Plug-In for Java 2 that downloads automatically upon a browser's request. Said applet establishes a connection to the system database 28 by invoking a JDBC Driver 130 Manager. A Connection object is used to pass SQL statements to main system database 128. The applet does not need to know which SQL statements are being sent, and is not involved in their generation. All SQL statements transferred to JDBC Driver 130 are obtained from the corresponding XML file 132. A security layer may be applied, if so desired, so that the open database port is safe. The exact security means (such as a Virtual Private Network (VPN) or other methods) are transparent to system 16 and are not further elaborated. VPN is the use of encryption in the lower protocol layers to provide a secure connection through the otherwise insecurity of Internet operations.

Supervisor-e 124 is a Windows application whose main function is to create, edit, publish and grant permissions to the XML files 132, which represent different online pages. Editing is done in the normal windows fashion—Drag & Drop, Cut & Paste to place objects on the screen; mouse clicking on objects (or menu selection) to change properties. Editing mode does not have to be “pixel precise”: it is left up to supervisor-i 126 applet to do the final arrangement of objects in the browser, according to window size.

Some of the objects that may be placed on the screen are:

Table Display—preferably a grid, which supervisor-i 126 applet can populate with system database 28 information;

Label—plain text, which may be assigned a hyperlink; and

Image—a web graphic (such as Graphics Interchange Format (GIF, a service mark of CompuServe) or Joint Photographic Experts Group (JPG) format), which may be assigned a hyperlink.

The table display may be chosen among one of the following basic types, to which additional types could be added on. Each type has its own unique set of columns, row selection options, row order options and summary options, such as:

The User Cumulative Time Display displays for each user/operation, the number of operations this user performed and their duration, since any selectable time such as midnight, beginning of month, etc;

The User Current Display displays for each user its current operation and time since any selectable time such as midnight, beginning of month, etc, based on selecting his latest unfinished operation;

The Operation Display displays for each operation or classification the number of operations performed by that classification and their duration, since any selectable time such as midnight, beginning of month, etc; and

The Event Display stores for all the events that took place since any selectable time such as midnight, beginning of month, etc, their time of occurrence, their destination (###) and the operation during which they took place.

User Selectable Time Period such as Daily Display

The following columns are among those that are available in this display:

User Name;

Group Name;

Operation;

Count;

Average Length;

Minimum Length; and

Maximum Length.

The following row selections are among those that can be made:

User(s) or all;

Group(s) or all; and

Operation(s) or all.

The preferred sort order for the rows is: first—group, then-user and last—operation.

User name, group and operation can be selected (on run-time) as filters; Count, average length, minimum length and maximum length can be used to set color codes.

The following summaries are among those that are available in this display:

User Name—none;

Group Name—none;

Operation—none;

Count—sum(count);

Average Length—sum(count*average length)/sum(count);

Minimum Length—min(minimum length); and

Maximum Length—max(maximum length).

An Exemplary User Current Display

The following columns are among those that are available in this display:

User Name;

Group Name;

Operation;

State Order;

State Name; and

Time.

The following row selections can be made

User(s) or all;

Group(s) or all;

Operation(s) or all;

State Order(s) (value for ongoing or 0 if finished) or all; and

State Name(s) (state name for ongoing or “[finished]”) or all.

The sort order for the rows is preferably: first—group then—user.

User name, group, operation and state can be selected (on run-time) as filters.

Time and status can be used to set color codes.

The following summaries are among those available in this display:

User Name—none;

Group Name—none;

Operation—none;

State Order—none;

State Name—none; and

Time—count(*).

An Examplary Operation Display

The following columns are available in this preferred display:

Operation;

Classification;

Count;

Average Length;

Minimum Length; and

Maximum Length.

The following row selections can be made in this preferred display:

Operation(s) or all; and

Classification(s) or all.

The preferred sort order for the rows is: first—operation then—classification.

Classification and operation can be selected (on run-time) as filters.

Count, average length, minimum length and maximum length can be used to set color codes.

The following summaries are among those available in this display:

Operation—none;

Classification—none;

Count—sum(count);

Average Length—sum(count

average length)/sum(count);

Minimum Length—min(minimum length); and

Maximum Length—max(maximum length).

Event Display

The following columns are among those available in this display:

Day Time;

Event Name;

User Name;

Group Name; and

Operation.

The following row selections are among those that can be made:

User(s) or all;

Group(s) or all;

Events(s) or all; and

Operation(s) or all.

The preferred sort order for the rows is decreasing time from a selectable event.

User name, group, operation and event can be selected (on run-time) as filters; event and operation can be used to set color codes.

The following summaries are among those available in this display:

Day Time—count(*);

Event Name—none;

User Name—none;

Group Name—none; and

Operation—none.

An Exemplary Table Display Appearance

The following is how an exemplary display object is preferably arranged by Supervisor-i 126 to appear in the browser, depending on the options selected. The parameters shown in Italic font are all part of the object's property page, which is user editable via Supervisor-e 124.

If DisplayBorder is on, the object is surrounded by a border, with the color defined in the page properties.

Inside, if ShowTitle is on, the title is displayed on the row, justified according to page properties.

Below the title, the display itself is displayed, with a grid if DisplayGrid is on.

The top row (two below the title) holds column names, if ShowColumnNames is on, for all SelectedColumns. Names are displayed in bold text with the page properties background color as their background.

Below, all values that match the row selection is displayed, if Show Values is on. If EnableColorCodes is also on, a colored background appears behind each value in the relevant column.

If either EnableRuntimeFilters or ShowSummaries is on, two additional rows are displayed:

In the first row, with bold text and the page properties background color as background, are displayed the following: “Avg.”, “Min”, “Max”, “Count”, “Sum” for summary columns. A “Filter” button for filter columns. Pressing that button prompts for a filter value.

In the second row, for all summary columns, the summary value is displayed (calculated for all selected/filtered rows); for all filter columns, the filter is displayed, or “*” if none is selected. Other fields remain empty.

The System Reactor

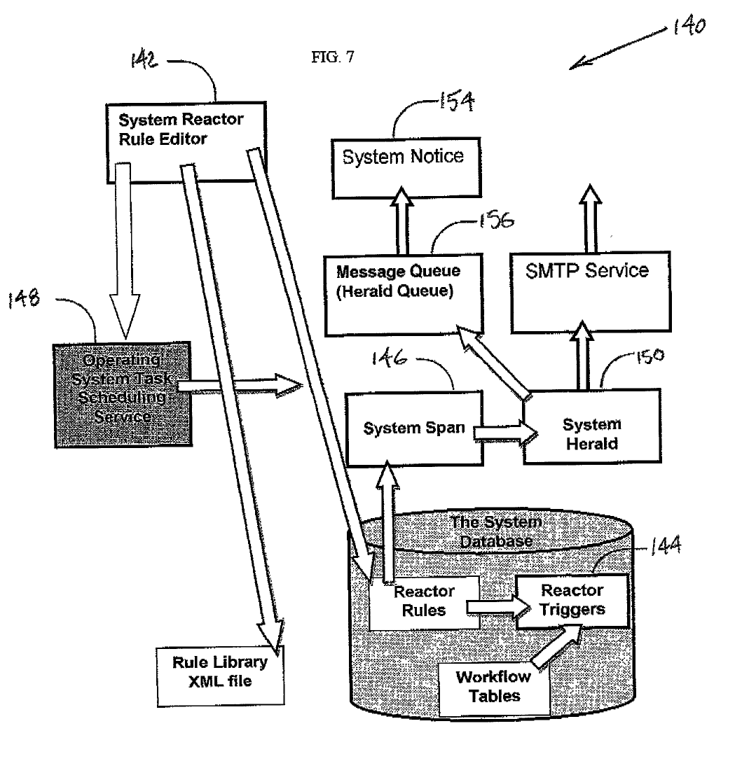

FIG. 7 is a schematic illustration of the functions of the system reactor 140, in accordance with a preferred embodiment of the present invention. System Reactor 140 is an alert management tool. It is designed to enable authorized personnel to define specific workflow conditions as alert rules, and specify how to respond when these conditions occur; and it includes various software components, which perform the actual testing of conditions and execution of responses.

Reactor Components

The following components form an exemplary system reactor 140, as shown in FIG. 7:

The Rules Editor 142 is an application that enables the user to visually create, edit and publish rules. Several “wizards” are included to make rule creation easier and more intelligent, as described in the following pages.

Reactor Triggers 144 are a set of database 28 triggers, activated upon insertion into the TimedOperations and TimedEvents, or updating (by adding FinishTime) to TimedOperations table, which supply the initial data for some of the condition tests

The System Span 146 checks conditions for rules with a fixed testing time (unlike rules which are constantly being checked by triggers). Span 146 is initiated when necessary by the operating system task scheduler 148 (like Windows Task Scheduler).

The System Herald 150 is a service that receives alerts from various sources (Span 146, triggers 144) and performs the required action, as defined by the appropriate rule. The reaction may be notifying users, executing a program etc. User notification may either be via e-mail (by SMTP 152) or with System's own “Notice”.

The System Notice 154 is a pop-up message agent. Notice 154 receives Herald messages that are buffered by a local operating system Herald queuing service 156 (like Microsoft's MSMQ). This can be used to differentiate Reactor alerts from regular e-mail.

Rules Editor 142 is a windows-based application, which can be installed on system server 26 hardware or on any remote PC. Working with the product is handled via a main menu, and using an “explorer” style GUI.

The main menu options are:

File;

Edit;

Tools;

Help; and

File Menu.

The “files” referred to are in fact rules, as they appear in the reactor “explorer” screen.

The file menu options are:

Load Rules;

Publish Rules;

Load Local . . . ;

Save Local . . . ;

New Library;

New Rule;

. . .

Print . . . ; and

. . .

Exit.

“load rules” loads the set of active rules from the server database, preventing them from being altered by another user for the duration of the editing session. “publish” updates the server with the edited rules.

“load local” and “save local” allow the user to maintain a local copy or backup of the set of rules; this set is not actually used until published on the server.

A “library ” is a collection of related rules.

The library sub-menu is:

Operation;

Classification;

State; and

Work Group.

A library can be created directly under the main library, or under an existing library. A library is preferably a different type than its parent libraries.

When “new library>Operation” is selected, a window pops up where the user can select one or more operations, by its name, from the operations table predefined by the administrator.

Similarly, “new library>Classification” opens a window which lists predefined classification types. “new library>State” opens a window where a state set and value can be selected.

“new library>Work Group” opens a window which lists predefined groups.

A “rule” is hereby referred to as the definition of a reaction taken when a certain condition occurs. Rules always relate to the libraries in which they reside. Exemplary relations may be, but need not always be, of the following forms:

General rule: if a rule is created inside the main (1st level) library, it relates to every operation performed by any person in the organization.

2nd degree rule: if a rule is created inside a 2nd level library, it relates to it, e.g., operations of a certain type.

3rd degree rule: if a rule is created inside a 3rd level library, it relates to it and its parent library, e.g., operations of a certain type performed by a specific group.

4th degree rule: if a rule is created inside a 4th level library, it relates to all parent libraries: operations of a certain type, performed by a specific group and given a particular classification.

The rule sub-menu is:

Timer;

Event; and

Quota.

When a timer rule is selected, a window opens with the following tabs:

Time selection—where the user is required to enter the operation length, which initiates a reaction.

Reaction—where the user selects the type of reaction taken.

Selecting an event rule opens a window with the following tabs:

Event selection—where the user can select an event from the events table predefined by the administrator.

Reaction—where the user selects the type of reaction taken.

When a quota rule is selected, a window opens with the following tabs:

Quota selection—where the user is required to enter the time of day when to check quota, the quantity to check for, and whether to invoke reaction if quantity is >,>=, =, <>, <=, or < than quota.

Reaction—where the user selects the type of reaction taken.

Edit Menu

Some of the possible edit menu options are:

Change Library . . . ;

Change Rule . . . ;

Active;

. . .

Cut;

Copy;

Paste;

. . .

Delete; and

Select All.

“Change library” reopens the library selection window (with either the operations, classifications or work groups table). “Change rule” opens the rule setting window, with the “reaction” tab on. “Active” can be marked on (default) or off, indicating whether a rule or a library is to be applied.

Tools Menu

Some of the possible the tools menu options are:

Libraries Wizard . . . ;

Rules Wizard;

Rules Analyzer;

. . .

Arrange Icons; and

. . .

View All.

“libraries wizard” opens up a series of windows that allow the user to quickly create a full set of libraries which match the predefined administrative tables. This option can be applied to the main library, to a specific 2nd or 3rd level library, or to a group of libraries of the same level (2nd or 3rd ), type and parent libraries type. The “create libraries” wizard works through the following steps, each with “next”/“previous”/“cancel” options:

Step 1: the wizard informs the user of the initial level of creation, parent libraries and how many levels could be created. For instance “2nd level: Workgroup. 3rd level: current 2 levels may be added.”

Step 2: the wizard asks for the type of library to create on the current level (operations, classifications or work group—but not a type which exists as a parent library). The user can also select whether to create libraries for all records in the administrative table, or only for those in use, i.e. for which records exist in the TimeSummary table (operations and classifications) or UserIndex table (work groups).

Step 3: if more than 1 level can be added, step 3 is similar to step 2. A “skip” option can be used to skip to step 5.

Step 4: if a third level can be added, the wizard informs the user of the library type which is created. For instance “4 th level: Classification”. The user selects whether to create libraries for all records or only for those in use. The “skip” option can be used.

Step 5: the program queries database 28 for all libraries as requested; when finished, a list of all the resulting libraries appears (each row in the form “Operation: OpName/Classification: CIName/Group: GrName”). All rows are initialy selected; the user may deselect rows. A “create” option can be used to create the selected libraries.

The rules sub-menu options are:

Timers . . . ;

Events . . . ; and

Quotas . . .

These options can be applied to the main library or to any number of lower level libraries.

The “timer” wizard works through the following steps, each with “next”/“previous”/“cancel” options:

Step 1: the wizard asks the user to select a minimum value, maximum value and interval (in selectable units such as minutes).

Step 2: similar to the “reaction” tab in the new/change-rule options.

Step 3: the wizard asks the user whether to create rules in all levels selected, or only in lowest level of each branch. A “create” option can be used to create the defined rules.

For instance, if the user chooses minimum=10, maximum=20, interval=5, than rules for “10:00”, “15:00” and “20:00” are created in each of the selected libraries.

The “event” wizard performs the following steps, each with “next”/“previous”/“cancel” options:

Step 1: the program queries the database for all event types; when finished, a list of all the resulting event names. All rows are initially selected; the user may deselect rows, or mark “only in use” (i.e., only events which have records in the “timed events” table).

Step 2: similar to the “reaction” tab in the new/change-rule options.

Step 3: the wizard asks the user whether to create rules in all levels selected, or only in lowest level of each branch. A “create” option can be used to create the defined rules.

A “quota” rule-wizard performs the following steps, each with “next”/“previous”/“cancel” options:

Step 1: the wizard asks the user to select a minimum value, maximum value and interval (in minutes) for day-time hours to check for quota.

Step 2: the wizard asks the user to select a starting and interval values for quantities to check for at each quota “checkpoint hour”, and a logical operator with which to perform the check.

Step 3: similar to the “reaction” tab in the new/change-rule options.

Step 4: the wizard asks the user whether to create rules in all levels selected, or only in lowest level of each branch. A “create” option can be used to create the defined rules.

The “arrange icons” menu preferred options are:

By Type;

By Name; and

Enabled.

If “by type” is selected, all icons appear sorted by type, libraries first. If “by name” is chosen, icons appear sorted by name, numerical values (like “5:00”) coming first. If “enabled” is chosen, icons are sorted with full libraries first, empty libraries second, enabled rules third and disabled rules last.

The “Display All” option is selected by default; if deselected, libraries which do not contain any rules become invisible.

An Exemplary “Reaction” Dialog

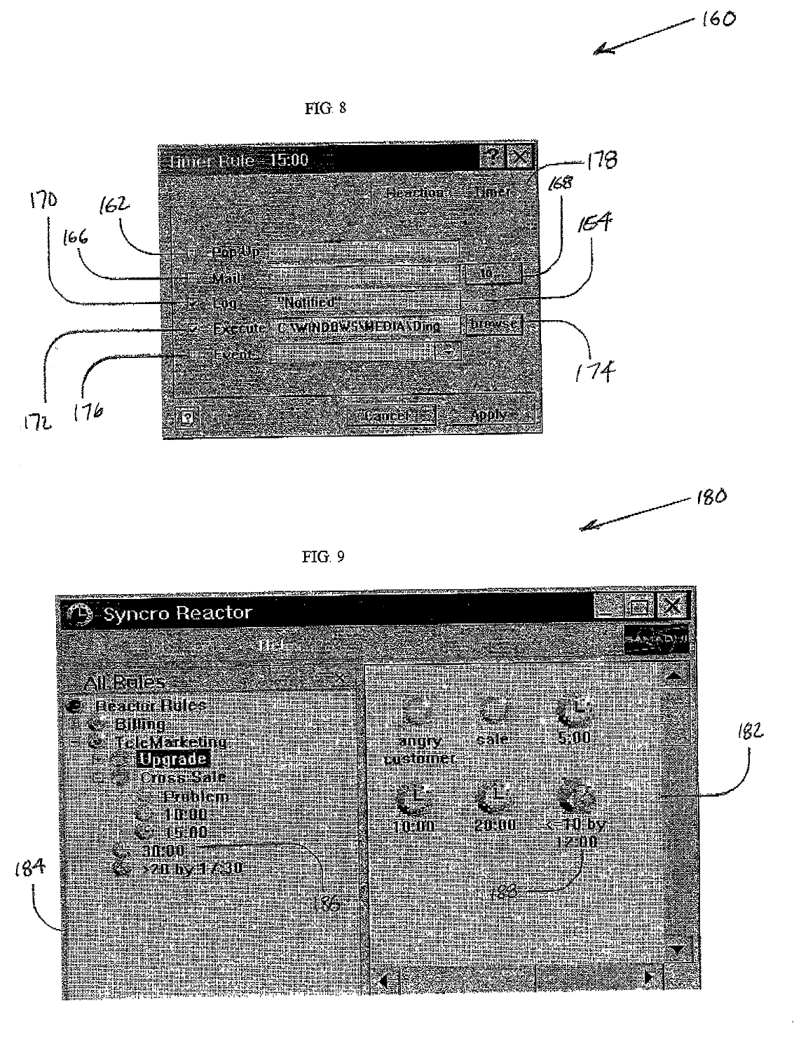

FIG. 8 is a computer screen image of a dialog box 160 illustrating the reactor dialog, in accordance with a preferred embodiment of the present invention. A similar form appears in the timer/event rule setting windows and in the timer/event rule wizards.

The user may set one or more reaction types to be activated when the timer/event condition is met.

The “Pop Up” 162 feature is utilized using the “notice” 154, installed on the client PC's. The control displays a message 164 on the screen (using the text entered in appropriate field in the reaction dialog), whenever the preset conditions are met.

The “Mail” option 166 sends a notification of the event or time, together with the type of operation, classification and user for whom the conditions were met, to a specified mail recipient. More than one recipient may be selected using the “To . . . ” button 168.

The “log” 170 option can be used to write a notice as a line in the log table, with the specified message, for later reference.

The “Execute” 172 option may be used to activate an executable program. The program may reside on a network library, accessible to all clients. Alternatively, the program may be run from the client local hard disk, in which case it is necessary for all clients to have the program located in the same local library.

A “browse” 174 button can be used to locate the executable.

The “Event” 176 option initiates an event, from the predefined list of events in the EventIndex table. The event is registered for the ongoing operation (for a “timer” rule 178 only). This option may be used to create time-dependant events, without having to hard-code them in the application.

An Exemplary Rule Editor Screen

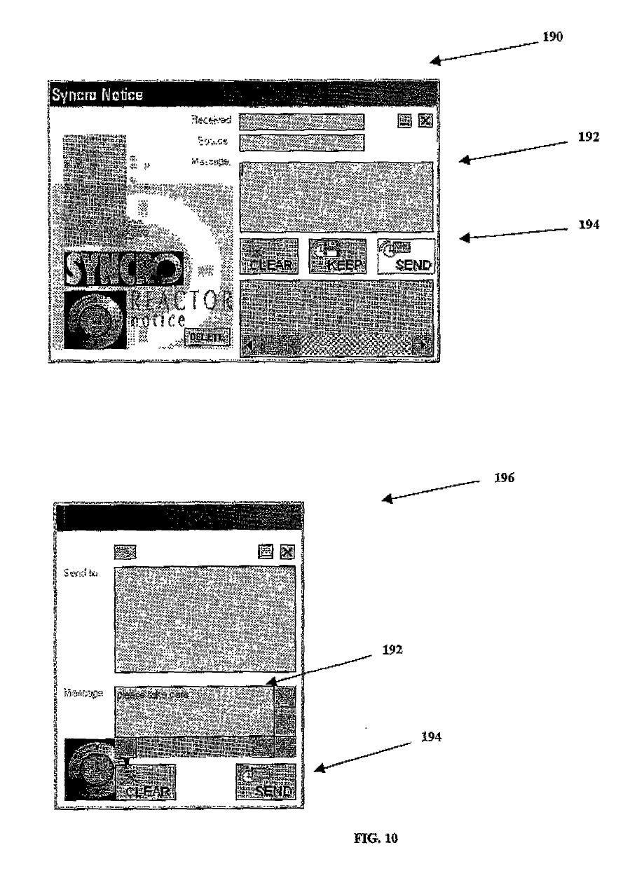

FIG. 9 is a computer screen image illustrating the creation of a time-dependent “event” 180, in accordance with a preferred embodiment of the present invention. In the example above, the “angry customer” rule which appears in the right pane 182, relates to an event called “angry customer” which occurs during a “telemarketing” operation classified as “upgrade”.

In the left pane 184 can be seen some rules, set to be checked when a “telemarketing” operation is classified “cross sale”. The “30:00” rule 186, however, relates to any “telemarketing” operation that reaches 30 minutes. The “<=10 by 12:00” rule 188, which appears in the right pane, describes an operation that takes place if no more than 10 telemarketing operations classified “upgrade” occur by 12:00.

Clicking on an icon selects it. Multiple choice through “shift” or “ctrl” keys is available.

Double-clicking on a library or rule icon is equivalent to “change library” or “change rule”, respectively.

Right-clicking an icon opens a floating “edit menu”. Right-clicking the “tree display” pane displays a floating “tools menu”. Right-clicking the “workspace” pane displays a floating menu with “new library “new rule ”, “paste”+the “tools” menu options.

An Exemplary Rule Analyzer Sub Menu

The sub-menu options are:

Timers . . . ;

Events . . . ; and

Quotas . . .

These options can be applied to the main library or to any number of lower level libraries. The analysis relates to all rules within these libraries. Analysis takes place according to the two-phase method described below.

Two Phase Rule Analysis

Rule analysis takes place in two phases—analysis of existing rules, and proposing new ones. The two phases are separate actions as far as the user is concerned, although they are related and may share some data.

Phase 1—Analyze Existing Rules

This phase has to do with examining database records and assessing the supposed frequency of alerts for the period examined, based on the current configuration of rules. This does not necessarily imply that such alerts have happened, and it is possible to check newly created rules against old data.

Phase 2—Proposing New Rules

This phase involves examining database records and calculating reasonable filters that create rules that produce the right amount of alerts, that is—not too much and not too little.

The exact thresholds are based on desired percentage of events, operations or employees to be pointed at by alerts.

Analysis & Proposal Scheme

The general scheme for analysis & proposal are as follows:

The user selects the library to be analyzed, in the Reactor explorer (for multiple libraries, the following is repeated for each library separately).

The user selects the rule type to be analyzed from the menu.

The user is prompted for the period for analysis.

The user is prompted for additional rule type specific parameters.

A rule type specific query selects data relevant to library and period into a temporary table.

A query selects all rules belonging to library and rule type into rules.

A rule type specific analysis procedure tests table against rules and parameters, producing a report.

A rule type specific proposal procedure tests table, rule type and parameters, producing a proposal.

The user is asked to select rules to be removed out of rules, and rules to be selected from a proposal and inserted into rules.

Examplary Timer Rules

Below is a breakdown of the 2-phase scheme for Timer rules.

Timer prompt

[symbol]

how many operations should fit rule Percentage→

use quick proposal procedure? Quick→

Timer Query

[symbol]

SELECT TiIndex, (TiFinishTime-TiStartTime) AS Length FROM TimedOperations

WHERE

(TimedOperations.TiOpIndex=Library.OpIndex OR Library.OpIndex IS NULL) AND

(Timedoperations.TiCIIndex=Library.CIIndex OR Library.CIIndex IS NULL) AND

(TimedOperations.TiStIndex=Library.StIndex OR Library.StIndex IS NULL) AND

(TimedOperations.TiGrIndex=Library.GrIndex OR Library.GrIndex IS NULL)

AND

(TimedOperations.TiStartTime IN Period)

AND

(TimedOperations.TiFinishTime IS NOT NULL).

TiStIndex and TiGrIndex are virtual fields calculated by selecting the matching AllowedStates.StIndex and AllowedUsers.UsGrIndex, respectively. Length represents the operation length.

Timer Query Report

First calculate the total number of operations in the table, then count number of operations that match all rules and calculate percentage.

Total=

SELECT count(*) from Table

SELECT Rules.RuleID, count(*) as Number, (Number/Total*100%) as Percent, (Percent-Parameters. Percentage) as Difference

FROM Rules, Table WHERE

(Table.Length>Rules.TimeLength)

GROUP BY Rules.RuleID

Timer Query Proposal

Proposal preparation depends on the selection of Parameters.Quick. If quick method is requested, the proposed TimeLength is calculated according to the mean and standard deviation of the Table population. If not, the Table is searched, and a value for TimeLength is sought that satisfies the percentage.

Quick Method:

Mean=AVG (Table.Length)

Dev=SDEV (Table.Length)

ErlangK=ROUND (Mean\hat{ }2/Dev\hat{ }2)

ErlangL=Mean/Dev\hat{ }2

Proposal=InvertErlang (percentage,ErlangK,ErlangL)

Slow (actual sampling) Method: ‘Accompanied by Progress Bar Display
‘Dim Bar as New ProgressBar
Initialize: ‘Bar.Min = 0

Total = SELECT count(*) from Table
Mini = MIN (Table.Length) ‘Bar.Max = Log(Total)/.
Maxi = MAX (Table.Length) ‘ Log(2) + 1
Guess = MINI + (MAXI - MINI) * (Parameters.Percentage / 100%)
Add = 0 ‘Bar.Value = 0

Start_Loop:

Number = SELECT count(*) FROM Table WHERE

(Table.Length > Guess)

Percent = ((Number+Add)/Total*100%)

‘Bar.Value = Bar.Value + 1

If ABS(Percent - Parameters.Percentage) < 1% then

Goto End_Proposal

If Percent > Parameters.Percentage) then

Table =
SELECT Table.Length FROM Table WHERE

(Table.Length => Mini) AND (Table.Length < Guess)

Add = Add + Number + 1
Maxi = Guess
Guess = (Guess + Mini) / 2

Else

Table =
SELECT Table.Length FROM Table WHERE

(Table.Length > Guess) AND (Table.Length <= Maxi)

Mini = Guess
Guess = (Guess + Maxi) / 2

Goto Start_Loop
End_Proposal:
Proposal = Guess ‘Bar.Value = Bar.Max

Event Rules

Below is a breakdown of the 2-phase scheme for Event rules.

Event Prompt Parameters.

how many events (per operation) should fit rule Percentage

→how many events (a day) should fit rule Daily→

Event Query Table

SELECT EvIndex, count(*) AS Number FROM TimedEvents, TimedOperations

WHERE

(TimedOperations.TiOpIndex=Library.OpIndex OR Library.OpIndex IS NULL) AND

(Timedoperations.TiCIIndex=Library.CIIndex OR Library.CIIndex IS NULL) AND

(TimedOperations.TiStIndex=Library.StIndex OR Library.StIndex IS NULL) AND

(TimedOperations.TiGrIndex=Library.GrIndex OR Library.GrIndex IS NULL)

AND

(TimedOperations.TiStartTime IN Period)

AND

(TimedOperations.TiFinishTime IS NOT NULL)

AND

(TimedOperations.TiIndex=TimedEvents.TvTiIndex)

GROUP BY TimedEvents.EvIndex

TiStIndex and TiGrIndex are virtual fields calculated by selecting the matching AllowedStates.StIndex and AllowedUsers.UsGrIndex, respectively. Length represents the operation length.

Event Query Report

For each event in Rules, it is pointed out if its frequency (according to Table) is within boundary of Percentage and Daily.

Temp=TimerQuery.Table

Operations=(SELECT count(*) from Temp)

Days=(DATEDIFF (dd, Period.Start, Period.End)+1)

SELECT Rules.RuleID, Table.Number, (Table.Number/Operations) as PerOp, (PerOp-Parameters. Percentage) as DifferencePerOp, (Table.Number/Days) as PerDay, (PerDay-Parameters.Daily) as DifferencePerDay

FROM Rules, Table WHERE

(Table.EvIndex=Rules.EvIndex).

Specification Page 32

Event Query Proposal

The proposed events is selected so that both the daily and per-operation conditions are met.

SELECT EvIndex FROM Table WHERE

((Number/Operations)<Parameters.Percentage)

AND

((Number/Days)<Parameters.Daily)

Quota Rules

Below is a breakdown of the 2-phase scheme for Quota rules.

Quota Prompt Parameters

how many users (out of total users in group) should fit rule Percentage

how [symbol] (a day) should fit rule Daily→

Quota Query Table

SELECT TiIndex, TiUsIndex,

CONVERT(DATE,TiFinishTime,3) AS Day ‘Style 3=dd/mm/yy

CONVERT(DATE,TiFinishTime,8) AS Time ‘Style 8=hh:mi:ss

FROM TimedOperations WHERE

(Timedoperations.TiOpIndex=Library.OpIndex OR Library.OpIndex IS NULL) AND

(TimedOperations.TiCIIndex=Library.CIIndex OR Library.CIIndex IS NULL) AND

(TimedOperations.TiStIndex=Library.StIndex OR Library.StIndex IS NULL) AND

(TimedOperations.TiGrIndex=Library.GrIndex OR Library.GrIndex IS NULL)

AND

(Timedoperations.TiStartTime IN Period)

AND

(Timedoperations.TiFinishTime IS NOT NULL)

TiStIndex and TiGrIndex are virtual fields calculated by selecting the matching AllowedStates.StIndex and AllowedUsers.UsGrIndex, respectively.

Quota Query Report

For each rule in Rules, the average number of users creating alerts is counted(according to Table) and check if it is within boundary of Percentage and Daily. A preliminary (not visible) report contains for combinations of rules & dates, how many alerts actually occurred every day.

Users=(SELECT count(DISTINCT UsIndex) from Table)

Temp=SELECT Rules.RuleID, Table.Day, Table.TiUsIndex, Count(Table.TiIndex) as

Amount FROM Rules, Table WHERE

Table.Time<Rules.DayTime

GROUP BY Rules.RuleID, Table.Day, Table.TiUsIndex

Preliminary=SELECT Rules.RuleID, Table.Day, Count(*) as Alerts FROM Rules,

Temp

WHERE

(Rules.RuleID=Temp.RuleID) AND

((Amount>Quantity AND Operator=‘>’) OR

(Amount>=Quantity AND Operator=‘>=’) OR

(Amount<Quantity AND Operator=‘<’) OR

(Amount<=Quantity AND Operator=‘<=’))

GROUP BY Rules.RuleID, Table. Day

Report=

SELECT RuleID, Avg(Preliminary.Alerts) as PerDay, (PerDay/Users) as PerUs, (PerUs-Parameters.Percentage) as DifferencePerUs, (PerDay-Parameters.Daily)

as DifferencePerDay

FROM Preliminary

GROUP BY Rules.RuleID

Quota Query Proposal

The proposed quantities is selected so that both the daily total and per-user conditions are met. Note that the algorithm uses parameters & tables defined in the previous steps, as if they were not de-allocated (or are global).

Limit=MlN(Parameters.Percentage*Users, Parameters.Daily).

Proposal preparation is as follows: since there may be several quota rules in a single library (for different hours), loop on each rule; then scan all days in period; for each day, sort users by their operation count, and find a daily quota that satisfies the limit; at the end, average all daily quotas, to find the rule quota; then, update the Proposal table.

‘Accompanied by Progress Bar Display
initialize: ‘Dim Bar as New ProgressBar

RuleCount = (SELECT count(DISTINCT RuleID) from Temp)
DayCount = (SELECT count(DISTINCT Day) from Temp)

‘Bar.Min = 0
‘Bar.Max = RuleCount
Proposal = SELECT RuleID, 0 AS Proposed FROM Temp
GROUP BY Rules.RuleID ‘Bar.Value = 0
Journal = SELECT Day FROM Temp GROUP BY Day
DECLARE ProposalCursor CURSOR FOR
SELECT RuleID FROM Proposal
DECLARE JournalCursor CURSOR FOR
SELECT Day FROM Journal
Loop rules:

FETCH NEXT FROM ProposalCursor INTO Rule
IF @@fetch_status<0 GOTO End_proposal
FETCH FIRST FROMJournalCursor INTO Jour
IF @@fetch_status<0 GOTO End_journal
DayTotal = 0 ‘Bar.Value = Bar.VaIue + 1
Loop_days:

Op = SELECT Operator FROM Rules
WHERE Rules.RuleID = Rule
IF Op IN (‘>’,‘>=’) THEN

DECLARE SearchCursor CURSOR FOR
SELECT Amount FROM Temp
WHERE RuleID = Rule AND Day = Jour
ORDER BY Temp DESCENDING

IF Op IN (‘<’,‘<=’) THEN

DECLARE SearchCursor CURSOR FOR
SELECT Amount FROM Temp
WHERE RulelD = Rule AND Day = Jour
ORDER BY Temp

IF Op IN (‘>=’,‘<=’) THEN

FETCH ABSOLUTE Limit FROM SearchCursor
INTO TempQuota

ELSE

FETCH ABSOLUTE Limit+1 FROM SearchCursor
INTO TempQuota

IF @@fetch_status<0

FETCH LAST FROM SearchCursor
INTO TempQuota

DEALLOCATE SearchQuota
DayTotal = DayTotal + TempQuota
FETCH NEXT Day INTO Jour
IF @@fetch_status=0 GOTO End_journal
GOTO Loop_days

End_journal:
UPDATE Proposal SET Proposed = INT(DayTotal / DayCount)
WHERE RuleID = Rule
GOTO Loop_rules
End_Proposal:
Proposal = Proposal ‘Bar.Value = Bar.Max

The Reactor Triggers 144

Rule Structure

The rule is defined by many parameters, generally grouped as following:

Library information (to which operations the rule applies;

Alert information (under which conditions an alert is activated); and

Response information (what action to take when alert is activated).

Detailed below are library and alert information, as the processing of these takes place (in part) at database 28 level. Response information is completely up to the “Herald” service 156, and does not require database 28 implementation other then reading it.

Library Information

Library information includes these data fields:

Operation;

Classification;

User Group; and

State.

With any of the above, a NULL value functions as a wild card. For a rule to be tested, an operation must comply with all non-NULL values.

Alert Information

Alert information includes these data fields:

Rule Type;

Delay;

Event;

Day Time;

Quantity; and

Logical Operator.

Rule type may either be T, E, Q or C for Timer, Event, Quota or Counter, respectively. Delay determines the length of the operation for testing by a Timer rule; Event determines the event type to be tested by an Event rule; Day Time, Quantity and Logical Operator define a Quota rule; Quantity and Logical Operator also define a Counter rule.

Event Rules

Event rules is tested by a trigger. A successful testing by this trigger directly leads to an alert activation (that is intercepted by the “herald” service).

Event Trigger: The trigger is set upon an INSERT to the TimedEvents table.

The test for an Inserted row is:

Logic: return the timed operation that “contains” the event, and any rule that applies to this event (there may be more than one rule, for instance—one rule for all operations of a certain type, and a more restricted rule for a specific user group).

SQL:

SELECT TiIndex,RuleID FROM Inserted, Timedoperations,SyRules WHERE

Inserted.TvTiIndex=Timedoperations.TiIndex AND

Inserted.TvEvIndex=SyRules.EvIndex AND

(TimedOperations.TiOpIndex=SyRules.OpIndex OR SyRules.OpIndex IS NULL)

AND

(TimedOperations.TiCIIndex=SyRules.CIIndex OR SyRules.CIIndex IS NULL) AND

(Timedoperations.TiStIndex=SyRules.StIndex OR SyRules.StIndex IS NULL) AND

(TimedOperations.TiGrIndex=SyRules.GrIndex OR SyRules.GrIndex IS NULL)

TiStIndex and TiGrIndex are virtual fields calculated by selecting the matching AllowedStates.StIndex and AllowedUsers.UsGrIndex, respectively.

Event Alert

An alert is set off by sending “Herald” 156 the results of the above trigger.

Timer Rules

Timer rules is tested by a trigger 144. A successful testing by trigger 144 initiates a timer within “herald” 156. This timer's alarm leads to an alert activation. Cancellation is also tested by a trigger 144.

Timer Trigger

Trigger 144 is set upon an INSERT to the TimedOperations table. The test for an Inserted row is Logic: return the timed operation and any rule that applies to this operation.

SQL:

SELECT TiIndex,RuleID FROM Inserted, SyRules WHERE

(TimedOperations.TiOpIndex=SyRules.OpIndex OR SyRules.OpIndex IS NULL)

AND

(TimedOperations.TiCIIndex=SyRules.CIIndex OR SyRules.CIIndex IS NULL) AND

(TimedOperations.TiStIndex=SyRules.StIndex OR SyRules.StIndex IS NULL) AND

(TimedOperations.TiGrIndex=SyRules.GrIndex OR SyRules.GrIndex IS NULL)

TiStIndex and TiGrIndex are virtual fields calculated by selecting the matching AllowedStates.StIndex and AllowedUsers.UsGrIndex, respectively.

Timer Alert

A timer (or timers) are activated by sending “Herald” 156 the results of the above trigger 144.

This timer ticks for a specified length of time, or until it is deactivated by a cancelation trigger 144. When the timer finishes ticking, it sets off the actual alert.

Timer Cancelation

The cancelation trigger is set upon an UPDATE to the TimedOperations table. The test for an Inserted row is:

Logic: return the timed operation(s) finished.

SQL:

SELECT TiIndex FROM Inserted WHERE

Timedoperations.TiFinishTime IS NOT NULL

Quota Rules

Quota rules is tested by a scheduled “Span” 146 component. The component queries for compliant users; users passing the test leads to an alert activation.

Quota Schedule

A scheduling or timer mechanism is activated for each rule, according to the DayTime column in the SyRules table.

Quota Query

Logic: step 1—return each user's count of operations (only those started and finished today) of the type tested by the rule. Step 2—return users for whom the rule has been met; step 2 is determined according to the Operator & Quantity columns in the SyRules table (there may be more than one user returned by the query).

Unlike Timer & Event rules, here the specific rule tested is given, and we first define a few parameters based on it.

SQL:

@Op is the rule's allowed operation index tested
@Cl is the rule's allowed classification index tested
@Gr is the rule's allowed group index tested
@St is the rule's allowed state index tested
@Qt is the rule's test quantity
@Lo is the rule's logical operator

SELECT @step1 =

SELECT TiUsIndex,count(TiIndex) AS Amount FROM
TimedOperations WHERE
(TimedOperations.TiOpIndex = @Op OR @Op IS NULL) AND
(TimedOperations.TiClIndex = @Cl OR @Cl IS NULL) AND
(TimedOperations.TiStIndex = @St OR @St IS NULL) AND
(TimedOperations.TiGrIndex = @GrIndex OR @Gr IS NULL) AND
(TimedOperations.TiStartTime >= GetDAte( ) ) AND
(TimedOperations.TiFinishTime IS NOT NULL)

GROUP BY TiUslndex

TiStIndex and TiGrIndex are virtual fields calculated by selecting the matching AllowedStates.StIndex and AllowedUsers. UsGrIndex, respectively.

SELECT @step2=

SELECT TiUsIndex FROM @Step1 WHERE

(Amount>@Qt AND @Op=‘>’) OR

(Amount>@Qt AND @Op=‘>=’) OR

(Amount<@Qt AND @Op=‘<’) OR

(Amount<=@Qt AND @Op=‘<=’)

Quota Alert

A timer (or timers) is activated by sending “Herald” 156 the results of the above query. Each user returned is to be considered an “alert source”, and for each—a separate message is sent.

Dataflow Between Reactor Components

Rules Editor 142 scans SyRules Table in the System main database to visually represent the existing rules to end-user. Rules Editor 142 refers to XML file 152 named “rules.xml” to obtain the hierarchical structure of the rules and organizes them into “libraries”. It is required that this file is placed at the same directory as Rules Editor 142 is located. In order to perform this step Rules Editor 142 uses DOM 128 to access the XML and ADO to access database 28.

Rules Editor 142 allows the creation and publishing of the rules. This action affects both SyRules Table, that actually stores the rule details and “rules.xml” file that contains the rule hierarchical relationship. If a “quota” rule is created, Rules Editor 142 establishes the connection with Windows Task Scheduler Service to set up the System Span Task. For Timed and Event rules no further Editor 142 action is needed.

Newly created Rules are stored in Rules Table (“SyRules”) of main system database 28. The added record number is passed to the triggered task as an execution parameter (e.g. command line parameter). The following code from Rules Editor 142 demonstrates this technique:

//EXECUTE INSERT SQL STATEMENT

//THE CODE IS OMITTED FOR BREVITY

//GIVE THE INSERTED RECORD NUMBER

_RECORDSETPTR PRESULTRST=PCNN→EXECUTE(L“SELECT @@IDENTITY”, NULL, ADCMDTEXT);

IF(PRESULTRST)

{

LRULENUM=PRESULTRST→FIELDS→GET_ITEM(OL)→GET_VALUE( );

PRESULTRST→CLOSE( );

}

//SEND THIS NUMBER AS COMMAND LINE PARAMETER TO SCHEDULER TASK

WCHAR_T WSZTEMP[8];

LPCWSTR PWSZPARAMETERS=::_LTOW(LRULENUM, WSZTEMP, 10);

HR=PITASK→SETPARAMETERS(PWSZPARAMETERS);

System span 146 receives the Rule number as command line parameter from Windows Task Scheduler. Given this number, system span 146 returns to SyRules with stored procedure “sp_Span” sending to it this number as parameter.

“sp_Span” procedure is depicted here:

Create Procedure sp_Span

@RuleID integer

WITH RECOMPILE

As

DECLARE @St integer

DECLARE @StO integer

DECLARE @StI integer

DECLARE @Gr integer

DECLARE @OpIndex integer

DECLARE @CIIndex integer

Get Rule details

SELECT @OpIndex=OpIndex FROM SyRules WHERE RuleID=@RuleID

SELECT @CIIndex=CIIndex FROM SyRules WHERE RuleID=@RuleID

SELECT @St=StIndex FROM SyRules WHERE RuleID=@RuIeID

SELECT @Gr=GrIndex FROM SyRules WHERE RuleID=@RuleID

SELECT @StO=StOrder FROM AllowedStates WHERE StIndex=@St

SELECT @StI=StSsIndex FROM AllowedStates WHERE StIndex=@St

SELECT TiUsIndex, COUNT(TiIndex) AS Amount

FROM TimedOperations, AllowedUsers

WHERE

(TiOpIndex=@OpIndex OR @OpIndex IS NULL) AND

(TiCIIndex=@CIIndex OR @CIIndex IS NULL) AND

((TiStOrder=@StO AND TiSSIndex=@StI)OR @St IS NULL ) AND

(TiUsIndex=AllowedUsers.UsIndex) AND ((AllowedUsers.UsGrIndex=@Gr)

OR (@Gr IS NULL)) AND

(DATEDIFF(dd, TiStartTime, GETDATE( ))=0) AND

TiFinishTime IS NOT NULL

GROUP BY TiUsIndex

This stored procedure produces Table IV in following format:

TABLE IV

| Column Name | Type |
|---|---|
| TiUsIndex | Integer |
| Amount | Integer |

Table IV is returned back to system span 146 executable as an ADO recordset. According to gathered rule details, system span 146 analyzes the data from a table trying to detect whether the rule was met. If so, system herald 150 is invoked.

When invoked, system herald 150 refers to relevant tables of the main database to obtain the notification details it needs to send a message. The notification recipient is preferably extracted as well as the transport (media) selected for every recipient. The following SQL statement is used through ADO to accomplish this task:

SELECT AdMachine, AdMail, RrMedia

FROM AdminUsers, RuleRecipients

WHERE AdminUsers.AdIndex=RuleRecipients.RrAdIndex

AND RrRuleID=@RuleID

Here @RuleID is expanded to the actual rule number being executed.

System herald 150 refers to the SyRules table once again in order to format the message being transferred. The message coding convention that is used for this process is defined below. Depending on detected transport (media) system herald 150 uses O/S message queue (like MSMQ) or SMTP to send the formatted message to all recipients.

An Exemplary Message Formatting

Whether by E-mail or Notice, the definition of the text message is the same. If both E-Mail and Notice channels are chosen as a response for a certain rule, both convey the same message.

The message can contain plain text and codes for different data items, and an exemplary list follows in Table V:

TABLE V

| Code | Data Item |
|---|---|
| [op] | Operation Name for Rule |
| [cl] | Classification Name for Rule |
| [gr] | User Group Name for Rule |
| [st] | State Name for Rule |
| [rt] | Rule Type Name |
| [tl] | Time Length for Alert |
| [ev] | Event Name for Alert |
| [dt] | Day Time for Alert |
| [qt] | Quantity for Alert |
| [lo] | Logical Operator for Alert |
| [pu] | Pop Up Address for Response |
| [em] | E-Mail Address for Response |
| [lg] | Message to Log for Response |
| [ep] | Execute Path for Response |
| [ce] | Create Event for Response |
| [us] | User Name* |
| [ti] | Time of Occurance* |
| [in] | Timed Operation Index* |
| [he] | Herald Server Name* |

These values are derived from the SystemDB.SyRules table (either as written in the table, or as reference to other tables) except the ones marked by (*), which are determind at execution time by the “Herald” service 150.

E-Mail Messaging

An E-Mail message consists of the following data:

From: [he]

To: [em]

Subject: [rt] rule activated by user: [us]

Message: user defined

“Notice” Messaging

A Notice message consists of the following data:

Source: [us]

Message: user defined

“Notice” Example Screen

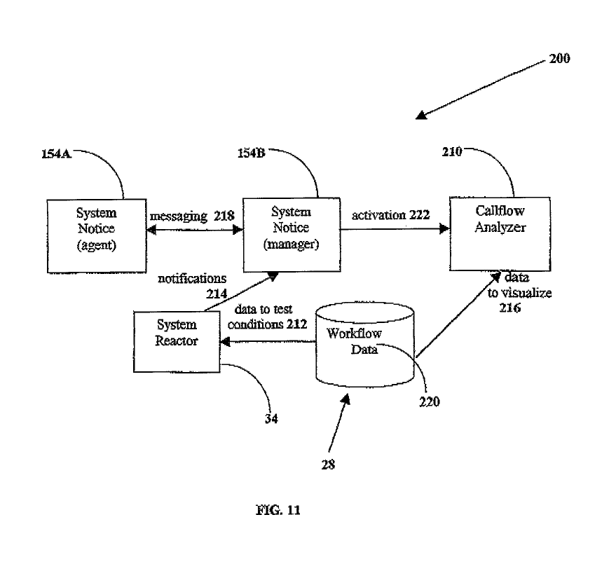

FIG. 10 is a computer screen image illustrating a notice message 190, in accordance with a preferred embodiment of the present invention.

The software component of system 10 provides the infrastructure for a methodology of employee management. This methodology assumes that:

a manager is to be notified when any of a set of business-specific conditions occur in the work process;

with this notification the manager can access certain data that can help him handle the situation; and

the manager, based on the data, assists the “agent” (an employee being monitored by system 10) in the work process.

The provisions of System Notice 154 are designed to help the manager exchange data with the agent and with database 28:

to support the act of notification;

for data access; and

for agent assistance.

System Notice 154 is the front end of an “executive messaging channel” that is independent of e-mail. This channel is used to support the management methodology described. The channel supports the following functions:

1. Creates an Alert Message by System Reactor 34.

2. Sends a New Message by a manager.

3. Displays an incoming Alert or New message sent by a manager or agent.

4. Temporarily stores incoming messages locally.

5. Replies to an Alert or New message sent by a manager or agent.

6. Retrieves Workflow Data, relevant to an Alert Message, sent by a manager.

7. Retrieves Screen-shots, relevant to an Alert Message, that were sent by a manager.

Notice 154 provides functions 2-5 and 7. Function 1 is handled by “Herald” 150 component of System Reactor 34. Notice 154 activates the Callflow Analyzer for function 6, as described hereinbelow, beginning on page 81.

“Notice” vs. E-Mail

Notice is the preferred alert-handling front end to notify the employees [agents] themselves in real-time, whereas ‘mail’ is used to alarm supervisors, managers etc.

The difference between agents and managers is in the functions accessible by the each. An agent is only allowed to access functions 3-5, while a manager can access function 2 (permission granted by system administrator 30), and functions 6-7 (accessible by installing additional software components at the manager's workstation).

E-Mail can also be used as an alternative/additional means of sending alerts—especially to remote, or mobile users, who do not have System Notice 154 nearby.

If the user is an agent, the “send” button 194 is normally disabled. If the user is a manager, he may use it to create a new message (function 2) or to forward/reply to an incoming message currently displayed (function 5). An agent may only reply to an incoming message 192, and may not create a new message. Pressing “send” 194 opens window 196.

Retrieving Workflow Data With “Notice”

A manager may install the Callflow Analyzer on his workstation, in which case Notice 154 can interact with the Callflow Analyzer in the following way:

1. Callflow Analyzer is put into “alert” mode.

2. Notice 190 pops-up when an incoming message 192 arrives.

3. If message 192 is an alert (direct or forwarded by another user), the relevant workflow data will appear on the Callflow Analyzer window as message 192 is displayed.

4. If a message 192 stored earlier is selected for reviewing, its workflow data appears on the Callflow Analyzer window.

To enable this, when message 192 is displayed on Notice 154 which has alert charateristics (alert source and time of creation), these characteristics are sent over to Callflow Analyzer, for retrieval and display of the relevant data.

Retrieving Screenshots With “Notice”

A manager with a sufficient security status, may use Notice 154 to retrieve an agent's screenshot in the following way:

1. A request arrives at an agent's workstation where Notice 154 is installed.

2. The request identifies the manager.

3. If the manager is recognized as having the requisite security status, Notice 154 takes a picture of the agent's screen and sends it over to the manager.

The screenshot is taken using the Windows Applications Program Interface (WinAPI32).

In workflow system 10, the request is initiated by the manager through his Callflow Analyzer. After performing the described process, the screenshot displayed on the manager's workstation, again through the Callflow Analyzer.

System Executive

System executive 36 is an application designed for the executive levels of the organization, to set up and print reports based on the system operational database 28.

System executive 36 is a windows-based application, which can be installed on system server 26 itself, or on any remote PC. Working with the product is done by main menu, through which the various executive options can be reached.

The main menu options are:

File;

Scenarios;

Options;

Window; and

Help.

File Menu

The “files” referred to are definitions that include a report template, and a set of values matching the parameters expected by the report.

The file menu options are:

New . . . ;

Open . . . ;

Close;

. . .

Save;

Save As . . . ;

. . .

Preview;

Destination . . . ;

Run; and

. . .

Exit.

When a new file is created, the user is first asked to select a template from the available report types. After a selection is made, the file is presented in the form of a window with the various fields required by the template, to be filled in by the user.

The actual reports are beyond the scope of this document, as they may vary, and templates could be added to the application freely.

When a report is saved, the user may choose whether date-type fields are to be used with absolute or relative values, relative indicating that the difference between current date and selected date should always be the same. A report is saved with the destination (printer, file, e-mail, screen).

Reports is saved to local files, with ”.set” indicating system executive 36 templates, ”.ser” indicating reports.

Options Menu

The options menu options are:

Report Levels;

Executables . . . ; and

Templates . . .

Report levels are handled like regular tables. Setting them enables a user to create and open only reports of a level equal to or lower than his own security level.

Choosing the Templates option opens an explorer window, which enables the user to set the library (local or network) where ”.set” files is searched for by default.

“Executables” are ”.sxr” files which, when “clicked”, open and run pre-defined reports without entering the executive application. When this option is selected, an explorer window opens with multiple choice available. The selected report set is then given a name and an (optional) expiration date.

”.sxr” files, when run, access database 28 through a unique account and password. They can be distributed to “non-sophisticated users” for simple production of common reports, without having to enter a user-name and password. These executables only work until their expiration date arrives.

“report levels” and “executables” options are only available to users with write permissions.

Scenario Menu

The “files” referred to are in fact definitions that include a report template, and a set of values matching the parameters expected by the report.

The Scenario menu options are:

Scenarios; and

Details.

Scenarios are handled in exactly the same format as the tables editing windows in the “Administrator” application: scenarios refer to the “ScenarioInfo” Table VIA; Operations refer to the “ScenarioDetails” Table VIB.

TABLE VIA

| Table | Feild Name | Description | Type |
|---|---|---|---|
| ScenarioInfo | | | |
| TABLE VIA | ScKey | Scenario Identifier Key | integer |
| | ScName | Scenario Descriptive Name | string |
| | ScBaseFrom | Scenario Calculation Base Start | date |
| | ScBaseTo | Scenario Calculation Base End | date |
| | ScEff | Scenario General Efficiency | integer |
| | | factor | |
| ScenarioDetails | | | |
| TABLE VIB | SdScKey | Scenario Detail Scenario Id Key | integer |
| | SdOpKey | Scenario Detail Operation Key | integer |
| | SdClKey | Scenario Detail Classification | integer |
| | | Key | |
| | SdWkFreq | Scenario Detail Weekly | integer |
| | | Frequency | |
| | SdEff | Scenario Detail Efficiency factor | integer |

These values can later be referred to by scenario-related reports. In such reports, usage of a specific scenario is possible by selecting the scenario from a list of available ones. Such reports are used for performing calculations where instead of using actual historical system 16 records, data is modified as follows:

values for operation lengths and quantities are averaged on base period (start to end dates);

all lengths are multiplied by general efficiency factor;

for specified operations and classifications (in details), lengths are multiplied again by detail efficiency factor.

Scenario related reports may use the calculated operation lengths together average frequencies, or with stated Weekly Frequency, for purposes of resource planning.

System Consultant

System consultant 38 is an application designed for the engineers and operations research staff of the organization, to set up and print special analysis reports based on system 16 operational database 28.

Standard consultant 38 reports are as follows:

The Workflow Trees report examines the operations and their linked keys, over a specified period of time. It sorts them into groups of chained operations, then goes over each group, counting how often a certain type of operation, leads to another certain type of operation, on a specific node of the chain. By transforming these summaries into percentages, it builds a diagram in the form of a probability tree, showing how operations form complete tasks, statistically.

The Trend Tracer is a collection of reports designed to point out trends in parameters obtainable from the “TimeSummary table”, which is designed for fast queries.

The Advanced Resource Planning (ARP) report takes into account nonlinear elements in the workflow using more complex mathematics (queuing methods) than the simple linear arithmetic of the resource planning report included in the basic package. This enables users to design resources for departments where the workflow is stochastic. ARP also uses user-defined scenarios to improvise on database 28 statistics.

Workflow Trees

This report examines the operations and their linked keys, over a specified period of time. It sorts them into groups of chained operations, then goes over each group, counting how often a certain type of operation leads to another certain type of operation, on a specific node of the chain.

By transforming these summaries into percentages, it builds a diagram in the form of a probability tree, showing how operations form complete tasks, statistically. On the arcs, a notation is made as to how long, on average, an operation takes to complete, when carried out from that specific node, that is, after a given preceding operation.

An intermediate level of processing is performed in order to cluster operations into trees, dividing unrelated operation clusters into separate trees. To achieve this, a minimal percentage threshold is set, under which a node is considered a breaking point. Branches emerging from a breaking point are separated into new distinct trees, marked as “broken” trees.

Should any broken trees be found, a final step of processing is taken to merge these trees into existing trees which begin with the same operation. In the merging process, percentages are recalculated according to the total summaries of the merged trees.

The report supplies the user with a default threshold value 0.05); a value of 0 means, no breaking points are to be declared.

Advanced Resource Planning

Advanced resource planning refers to nonlinear elements in the workflow which require calculating a level of service and, therefore, more complex mathematics than the simple linear arithmetic of the resource planning report included in the basic package.

ARP performs a scenario-based analysis, like the basic resource planning (RP). Here the two applications take different courses. Basic RP simply groups together operations for specific workgroups, and according to the specific scenario, calculates how many of these operations take place in the forecast period and how long they take. It then is able to plan the resources needed for that volume of work.

ARP works for one workgroup at a time. It first requires the user to mark up operations which form that group's on-line services. It then asks for the user to set a service level requirement, in terms of waiting time, availability percentage or similar parameters of queueing theory. All these settings are saved as part of the ”.ser” file.

ARP then calls up the Queue Plan Interface (QPI) component, described hereinbelow. QPI accepts a service time (comprising the service operations) and off-line time (comprising of all other operations), and the required level of service. QPI then returns the number of employees required for that group.

Variations on this calculation include Monthly, Weekly, Daily or Hourly ARP reports.

Trend Tracer

The trend tracer is a collection of reports designed to point out evident trends in parameters obtainable from the “TimeSummary table”, which is designed for fast queries.

The trend tracer creates a table, which is split into time periods. The size of the periods can be selected by the user for Monthly, Weekly or Daily reports. The user selects a range of dates for the report, and may also mark up selected users, groups or operations to examine.

In that table, the following parameters are being examined:

Number of operations, for each operation type;

Number of operations per user, for each operation type; and

Average length of operation, for each operation type.

In addition, the “classification trend tracer” also checks the percentage of classification, for each classification under an operation.

For each parameter, the trend tracer searches for a pat tern based on some basic statistical regression methods. Only parameters with significant trends appear in the final report produced, along with the trend line formula.

The report definition screen supplies the user with a default confidence level (95%), which could be altered by the user.

QPI Interface

The QPI interface is a part of system 16 resource planning engine. At its heart is a calculation method (the main subroutine of which is listed hereinbelow) which accepts as input the parameter fServers (which represents the number of employees doing a given set of activities), and based on activity data (provided as various properties of the object setting) calculates properties of the process output (such as service level) and throughput.

This calculation is a numerical approximation of a statistical formula that describes the behavior of a service queue interwoven with offline activities. That enables the system 16 ARP report to plan resources based on service level, as well as on simple multiplication of operation time and quantity.

PUBLIC SUB RUNMODEL(FSERVERS As INTEGER)

ON ERROR GoTo ERRTRAP

DIM LA( ) As DOUBLE

DIM MU( ) As DOUBLE

DIM P( ) As DOUBLE

DIM CUM( ) As DOUBLE

DIM SW( ) AS DOUBLE

DIM ABW( ) AS DOUBLE

DIM AB( ) As DOUBLE

DIM SPR( ) AS DOUBLE

DIM AW( ) AS DOUBLE

DIM I As INTEGER, J As INTEGER, K As INTEGER

DIM s As DOUBLE, T AS DOUBLE, Q As DOUBLE, R As DOUBLE

DIM PAB As DOUBLE, EEN As DOUBLE

DIM EAB As DOUBLE, PIS As DOUBLE

DIM AWS As DOUBLE, ESE As DOUBLE

DIM AWW As DOUBLE, AWV As DOUBLE

DIM AWAB As DOUBLE, RO As DOUBLE

DIM WT As DOUBLE, ST As DOUBLE

DIM UB AS INTEGER

DIM XX As DOUBLE

DIM DIVIDER As DOUBLE

DIM FARRIVALS AS DOUBLE

DIVIDER=TIMESLICE/60

IF FRMBRANCH.PNLRESULTSTITLE.CAPTION=” [symbol] ” AND FSERVERS>

CURRENTLINESNUMBER

THEN

CURRENTLINESNUMBER=GETTOZAOT

ENDIF

IF SETTING.GETLINESASSIGNMENTMETHOD=1 THEN

IF NOT (CURRENTLINESNUMBER/SETTING.GETLINESSERVERSRATIO)=CINT(FSERVERS) THEN

CURRENTLINESNUMBER=CINT(FSERVERS)

SETTING.GETLINESSERVERSRATIO

ENDIF

END IF

IF SETTING.GETLINESASSIGNMENTMETHOD=2 THEN

IF NOT (CURRENTLINESNUMBER/(SETTING.GETLINESMAXWAITINGTIME/

SETTING.GETAVERAGESERVICETIME+1))=CINT(FSERVERS) THEN

CURRENTLINESNUMBER=(SETTING.GETLINESMAXWAITINGTIME/

SETTING.GETAVERAGESERVICETIME+1)

CINT(FSERVERS)

END IF

END IF

IF FSERVERS>CURRENTLINESNUMBER THEN

EXITCODE=−10

EXITMESSAGE=“ [symbol] ”

EXIT SUB

END IF

IF FSERVERS<=0 THEN

EXITCODE=−11

EXITMESSAGE=“ [symbol] ”

EXIT SUB

END IF

REDIM LA(CURRENTLINESNUMBER+1)

REDIM MU(CURRENTLINESNUMBER+1)

REDIM P(CURRENTLINESNUMBER+1)

REDIM CUM(CURRENTLINESNUMBER+1)

REDIM SW(CURRENTLINESNUMBER+1)

REDIM ABW(CURRENTLINESNUMBER+1)

REDIM AB(CURRENTLINESNUMBER+1)

REDIM SPR(CURRENTLINESNUMBER+1)

REDIM AW(CURRENTLINESNUMBER+1)

FARRIVALS=ARRIVALS*(FORECASTFACTOR/SETTING.GETKP)

LA(CURRENTLINESNUMBER)=0

MU(0)=0

UB=CURRENTLINESNUMBE−1

FORI=0 TO UB

LA(I)=FARRIVALS

NEXT I

FOR I=1 TO FSERVERS

MU(I)=SERVICERATE*I

NEXT I

XX=FSERVERS*(SERVICERATE-ABANDONRATE)

FOR I=FSERVERS+1 To CURRENTLINESNUMBER

MU(I)=XX+ABANDONRATE*I

NEXT I

s=1

T=1

FORK=1 To CURRENTLINESNUMBER

T=T*LA(K−1)/MU(K)

S=S+T

NEXTK

P(0)=1/s

FOR K=1 To CURRENTLINESNUMBER

P(K)=P(K−1)*LA(K−1) MU(K)

NEXT K

R=0

UB=FSERVERS−1

FOR I=0 To UB

AB(I)=0

SPR(I)=1

R=R+P(I)

AW(I)=0

CUM(I)=0

NEXT I

PIS=R

s=0

T=0

R=0

UB=CURRENTLINESNUMBER−1

FOR I=FSERVERS To UB

Q=ABANDONRATE/MU(I+1)

AB(I)=Q+(1−Q)*AB(I−1)

AW(I)=Q/ABANDONRATE+(1−Q)*AW(I−1)

SPR(I)=(1−Q)*SPR(I−1)

CUM(I) CUM(I−1)+1/MU(I)

SW(I)=SPR(I)*CUM(I)

T=T+P(I)*AW(I)

S=S+P(I)*AB(I)

R=R+P(I)*SW(I)

NEXT I

PAB=s

EAB=PAB*FARRIVALS

EEN=(1−P(CURRENTLINESNUMBER))*FARRIVALS

AWS=3600*R/(1−P(CURRENTLINESNUMBER)-PIS-PAB)

ESE=EEN-EAB

AWW=3600*T/(1−PIS-P(CURRENTLINESNUMBER))

AWV=3600*T/(1−P(CURRENTLINESNUMBER))

AWAB=3600*(T-AWS*(1−P(CURRENTLINESNUMBER)-PIS-PAB)/3600) PAB

RO=((1−P(CURRENTLINESNUMBER)-PAB)*FARRIVALS)/(FSERVERS*SERVICERATE)

PARAMETERS.SETPARAMETERVALUE UCAVREAGEWAITINGTIME, AWV

PARAMETERS.SETPARAMETERVALUE WAITTIME4WAITING, AWW

PARAMETERS.SETPARAMETERVALUE WAITTIME4ABANDON, AWAB

PARAMETERS.SETPARAMETERVALUE WAITTIME4SERVICED, AWS

PARAMETERS.SETPARAMETERVALUE EXTARRIVALRATE, (ARRIVALS*FORECASTFACTOR)* DIVIDER

PARAMETERS.SETPARAMETERVALUE EFFARRIVALRATE, EEN*DIVIDER

PARAMETERS.SETPARAMETERVALUE MAXSERVICERATE, FSERVERS*SERVICERATE*DIVIDER

PARAMETERS.SETPARAMETERVALUE EFFSERVICERATE, ESE*DIVIDER

PARAMETERS.SETPARAMETERVALUE BUSYSIGNALRATE, (FARRIVALS-EEN)*DIVIDER

PARAMETERS.SETPARAMETERVALUE PERCBUSYSIGNAL, P(CURRENTLINESNUMBER)*100

PARAMETERS.SETPARAMETERVALUE PERCIMMEDIATESERVICE, PIS*100

PARAMETERS.SETPARAMETERVALUE PERCWAITING, 100*(1−PIS-P(CURRENTLINESNUMBER))

WT=100*(1−PIS-P(CURRENTLINESNUMBER))*EXP(-SETTING.GETTHRESHOLDVALUE/AWW)

PARAMETERS.SETPARAMETERVALUE PERCWAITMORETHAN_T, WT

PARAMETERS.SETPARAMETERVALUE PERCWAITLESSTHAN_T, 100*(1−P(CURRENTLINESNUMBER)-PIS)-WT

PARAMETERS.SETPARAMETERVALUE CABANDONRATE, EAB*DIVIDER

PARAMETERS.SETPARAMETERVALUE PERCABANDONING, 100*PAB

ST=100*(1−PIS-P(CURRENTLINESNUMBER)-PAB)*EXP(-SETTING.GETTHRESHOLDVALUE/AWS)

PARAMETERS.SETPARAMETERVALUE PERCSERVEDAFTERWAIT_T, ST

PARAMETERS.SETPARAMETERVALUE PERCABANDONAFTERWAIT_T, WT-ST

PARAMETERS.SETPARAMETERVALUE EFFTRAFICINTENSITY, RO*DIVIDER

PARAMETERS.SETPARAMETERVALUE PERCOFAVAILABILITY, 100*(1−RO)

PARAMETERS.SETPARAMETERVALUE IMMEDIATEANDLESSTHAN_T, (PIS*100)+(100*(1−P(CURRENTLINESNUMBER)-PIS)-WT)

PARAMETERS.SETPARAMETERVALUE TOTALINBRANCHTIME, SETTING.GETAVERAGESERVICETIME*(1−PAB-P(CURRENTLINESNUMBER))+AWV

EXITCODE=0 ‘OK

EXIT SUB

ERRTRAP:

EXITCODE=-ERR.N UMBER

EXITMESSAGE=ERROR

END SUB

The Callflow Analyzer

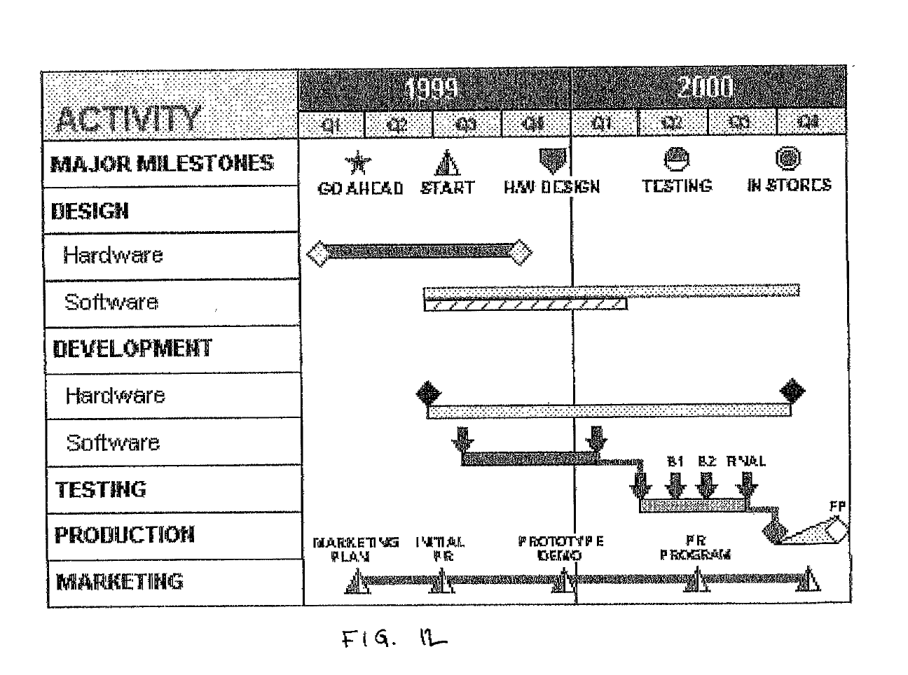

FIG. 11 is a flow chart that schematically illustrates the callflow analyzer function 200, in accordance with a preferred embodiment of the present invention.

The software component of system 10 provides the infrastructure for a methodology of employee management. This methodology assumes that:

a manager is to be notified when any of a set of business-specific conditions 212 are derived from the workflow data 220 stored on database 28, causing notifications 214 to be sent to the manager workstation component of system notice 154A;

with notification 214 the manager can access visualizing data 216 that can help him handle the situation; and

the manager, based on data 216, exchanges messages 218 with the “agent” (an employee being monitored by system 10) system notice component 154B to assist the agent in the work process.

The Callflow Analyzer 210 (CFA) is a primary tool for visualizing part of the relevant workflow data, and is activated 222 by Notice 154.

CFA is a system for analyzing the information stored in System Database 28, in a way that produces Gantt charts.

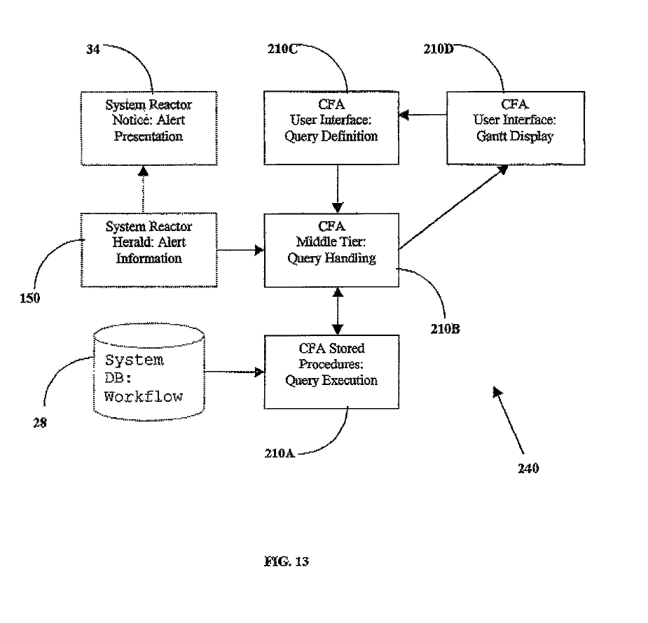

FIG. 12 is a graph that schematically illustrates the function of a Gantt chart 230, in accordance with the prior art.

The Gantt chart is a basic means of visually presenting a project program. Essentially a bar chart, it is a useful summary of where the project stands.

Each bar 232 constitutes an aggregate of numerous sub-tasks, which are each continued in their own Gantt chart. A hierarchy of Gantt charts can therefore be built up. The Gantt chart is often used as the benchmark by which a project's progress is measured, and is commonly circulated to all team leaders.

Gantt charts can describe either a specific set of logically linked operations (which are referred to as a “case”) or a historical summation of multiple cases.

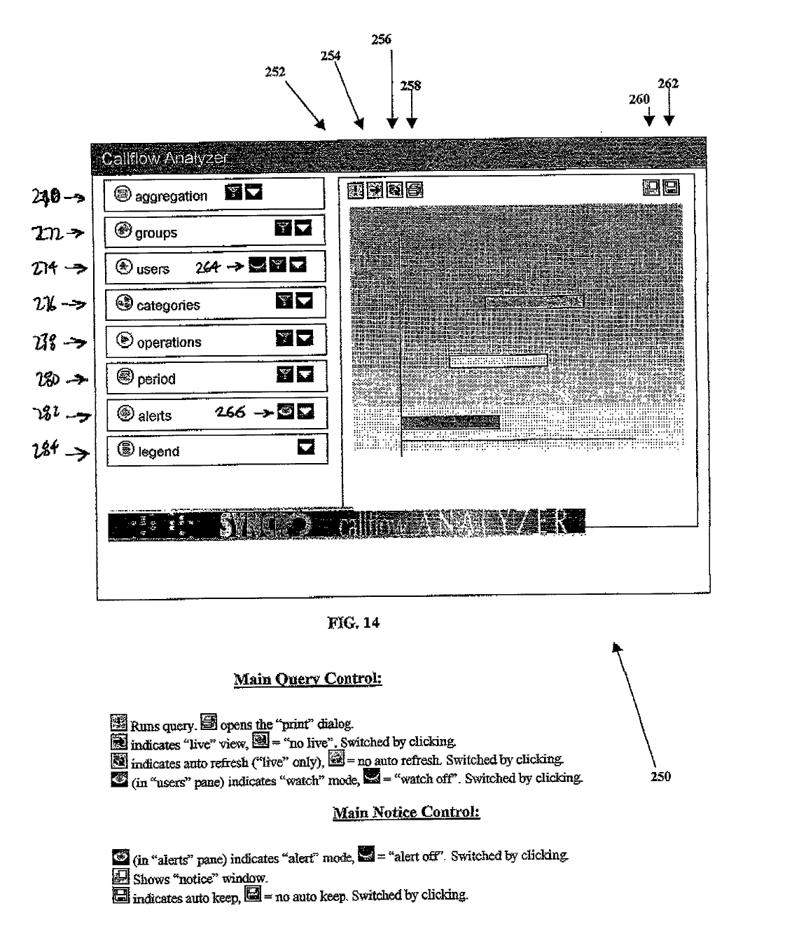

FIG. 13 is a schematic illustration of the functions of the callflow analyzer 240, in accordance with a preferred embodiment of the present invention.

The CFA system's structure is a unique combination of data analysis procedures, display techniques, and interaction of various software components, in a way that supports the proposed management methodology.

The various sub-components of the CFA, are described as follows:

CFA Stored Procedures

CFA stored procedures 210A generally return a table containing Gantt chart data 210D, based on certain parameters given to them. Gantt chart data 210D is returned as rows, each row relating to a different activity 232 and containing the following these columns:

1. Label: the description of the activity 234

2. X1: beginning of activity 236

3. X2: ending of activity 238

4. Number: number of operations sampled

There are several variations of stored procedures, used by the system for different types of queries. These are:

1. Sy_VAW_Ca: returns a Gantt with activities aggregated to “categories” (families of similar types of operations) for low-resolution analysis.

2. Sy_VAW_Op: returns a Gantt with activities aggregated to “operations” for high resolution analysis.

3. Sy_VAW_Ca_Us: returns a Gantt with categories, with each user's data shown seperately. To differentiate users, an additional column ‘Series’ is returned.

4. Sy_VAW_Ca_Gr: returns a Gantt with categories, with each user-group's data shown seperately. To differentiate groups, an additional column ‘Series’ is returned.

5. Sy_VAW_Op_Us: returns a Gantt with operations, with each user's data shown separately. To differentiate users, an additional column ‘Series’ is returned.

6. Sy_VAW_Op_Gr: returns a Gantt with operations, with each user-group's data shown seperately. To differentiate groups, an additional column ‘Series’ is returned.

7. Sy_VAW_Us: returns a Gantt for a specific user, for a single case of operations.

Procedures 1-6 are given the following parameters:

1. UserIndex: selects a specific user for query, or (if NULL) all users.

2. GroupIndex: selects a specific group for query, or (if NULL) all groups.

3. Case: selects a specific case for query, or (if NULL) all cases.

4. OperationIndex: selects a specific operation for query, or (if NULL) all operations.

5. CategoryIndex: selects a specific category for query, or (if NULL) all categories.

6. FromDate: earliest time for query or (if NULL) since first entry.

7. ToDate: latest time for query or (if NULL) until last entry.

8. Live: if equals 1, query includes currently ongoing activity.

Procedure 7 is given these parameters:

1. UserIndex: selects a specific user for query, or (if NULL) all users.

2. Date: selects a specific time to query.

These procedures all follow the same core logic:

1. For procedures 1-6: Select operations matching input parameters.

2. For procedure 7: locate an operation which took place in the specified time, find its case, and select operations of the same case.

3. Group together operations belonging to a similar case (identified by the TiCase column in the TimedOperations 56 of Table I).

4. For procedures 1,3-4: Group those operations again, as categories, with each category starting with the earliest-starting operation in that category, and ending with the latest-finishing operation in the category.

5. In each case, find the earliest activity (operation or category), and mark its start as zero-time of the case.

6. compute all operation beginning and finishing times relative to zero-time of the case.

7. For every activity, compute the average beginning and finishing relative times, over the different cases.

8. For procedures 3-6: compute the averages over different users or groups, as well.

The SQL script for these procedures (MS T-SQL version) is attached at the end of this document.

CFA Middle Tier

The CFA middle tier 210B has the task of receiving various inputs, indicating the type of querying required, running the appropriate stored procedures and delivering the data returned to Gantt display 210D.

From the user interface, CFA gets query definitions that are selected specifically by the user. From System Herald 150, CFA gets additional notification on incoming alerts, that are transformed into appropriate query definitions.

The following query definitions are handled by the middle tier:

1. Aggregation method: selects which of procedures 1-6 to use.

2. “Watch” mode: selects procedure 7, with Date=NULL (current time).

3. “Live” mode: queries run with Live=1.

4. “Auto Refresh” mode: queries are executed repeatedly

5. Time period: date and time are combined to FromDate and ToDate.

6. User multiselection: transformed to a series of queries for each User.

7. Group multiselection: transformed to a series of queries for each Group.

8. Operation multiselection: transformed to a series of queries for each Operation.

9. Category multiselection: transformed to a series of queries for each Category.

10. User multiselection: transformed to a series of queries for each user.

FIG. 14 is a computer screen image illustrating the main window of the CFA user interface 250, in accordance with a preferred embodiment of the present invention.

Main Query Control: [symbol]
252 Runs query. [symbol] 258 opens the “print” dialog. [symbol]
254A indicates “live” view, [symbol] 254B = “no live”. Switched

by clicking.

[symbol]

256A indicates auto refresh (“live” only), [symbol] 256B = no auto

refresh. Switched by clicking.

[symbol]

(in “users”[274 pane) indicates “watch” mode,

[symbol]

264 = “watch off”. Switched by clicking.

Main Notice Control: [symbol]
266 (in “alerts” 282 pane) indicates “alert” mode,

[symbol]

= “alert off”. Switched by clicking.

[symbol]

260 Shows “notice” window. [symbol]
262A indicates auto keep, z,811 262B = no auto keep.

Switched by clicking.

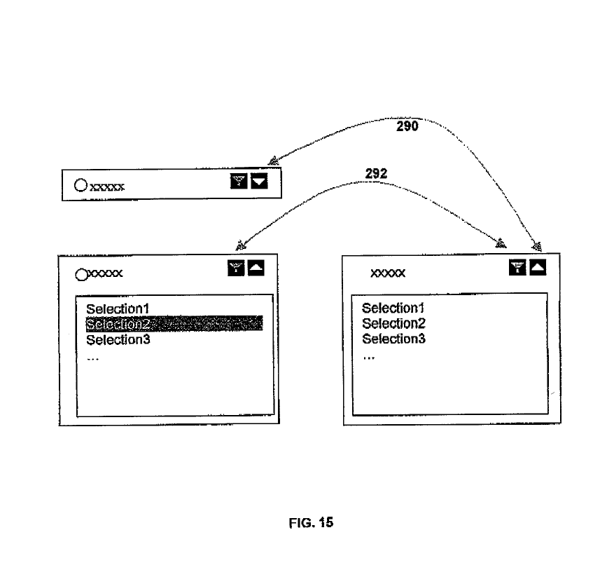

FIG. 15 is a computer screen image illustrating the “roll” and “filter” features of the main window of the CFA user interface, in accordance with a preferred embodiment of the present invention.

Roll Up/Down:

A click on the Roll icon 290 switches between rolled-up and rolled-down pane.

Double-click on the Roll-Down icon rolls the pane down while rolling all others up.

Filter On/Off:

A click on the Filter icon 292 switches between filter-off (same as selecting “ALL”) and filter-on (previously selected from the list, or currently being selected). Filter is switched on when selection is in progress.

Pane Space Allocation:

All rolled-down panes occupy the same space when not in selection: whatever space is allowed by the size of the main form, minus the height of all rolled-up panes, is divided between all rolled-down panes.

Cursor Shape:

[symbol] Normal state

[symbol] Waiting for query results

[symbol] Mouse over “clickable” button

Keyboard Shortcuts:

F5=Run Query;

CTRL+N=Show Notice;

CTRL+P=Open “Print” Dialog;

CTRL+W=Toggle “Watch” Mode; and

CTRL+A=Toggle “Alert” Mode.

Pane Contents:

The following “clickable” entry sub-windows are available on the CFA:

Aggregation 270;

Groups 272;

Users 274;

Categories 276;

Operations 278;

Period 280;

Alerts 282; and

Legend 284.

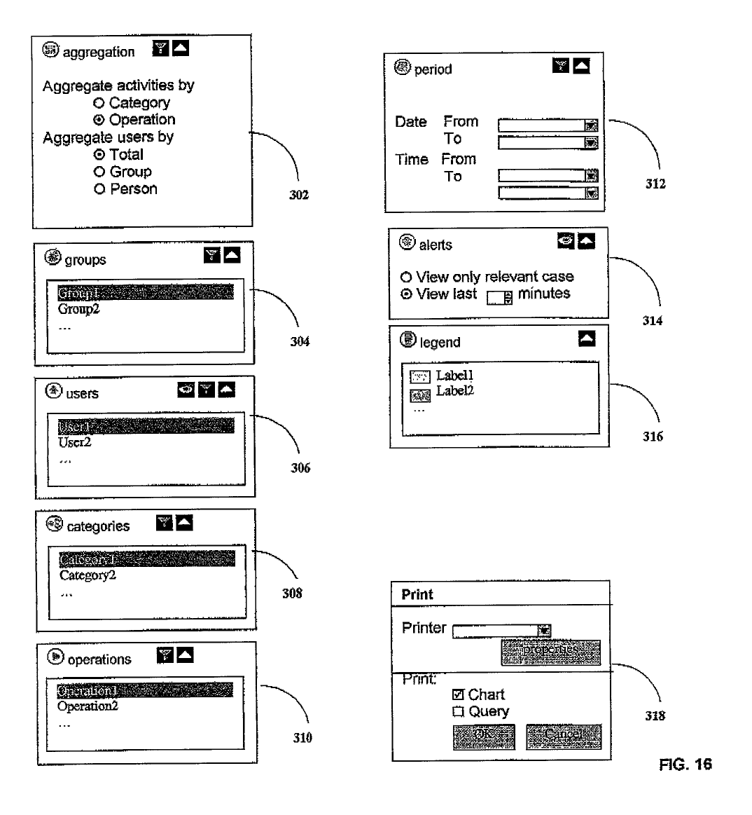

FIG. 16 is a set of computer screen images illustrating the full sub-windows of the CFA user interface, in accordance with a preferred embodiment of the present invention. FIG. 16 shows each of the CFA full sub-windows that are displayed when the corresponding entry sub-window is clicked on CFA user interface 250.

The following full sub-windows are displayed accordingly:

Aggregation 302;

Groups304;

Users 306;

Categories 308;

Operations 310;

Period 312;

Alerts 314; and

Legend 316.

Also, when “print” dialog 258 is opened, print dialog box 318 is displayed.

“Click to Query”:

Some of the query parameter selection is available by direct manipulation of the Gantt chart. The manager clicks on elements of the chart with the mouse, thereby changing the parameters accordingly and he then re-queries the information. The “Click to Query” rules are as follows:

1. Zoom on Category: if activity is aggregated by Categories, and a manager right-clicks on a specific bar of a Category, a new query is run with the selected Category as filter and activity aggregated by Operations.

2. Zoom on Group: if agents are aggregated by Groups, and a manager left-clicks on a specific bar of a Group, a new query is run with the selected Group as filter and agents aggregated by Users.

3. Zoom on Total: if agents are aggregated as Total, and a manager left-clicks on a specific bar of a Category/Operation, a new query is run with the selected Category/Operation as filter and agents aggregated by Groups.

4. Zoom Out Categories: if activity is aggregated by Operations, and a manager right-clicks on the chart (not on a bar), a new query is run with activity aggregated by Categories.

5. Zoom Out Groups: if agents are aggregated by Users, and a manager left-clicks on the chart (not on a bar), a new query is run with agents aggregated by Groups.

6. Zoom Out Total: if agents are aggregated by Groups, and a manager left-clicks on the chart (not on a bar), a new query is run with agents aggregated as Total.

### Script of CFA Stored Procedures

CREATE PROCEDURE Sy_YAW_Ca

@UserIndex int, @GroupIndex int, @Case varchar(20), @OperationIndex int, @CategoryIndex int, @FromDate datetime, @ToDate datetime, @Live int AS SET NOCOUNT ON CREATE TABLE #res (label int, X int, L int) DECLARE @tg varchar(30), @first datetime, @prev varchar(30), @label int, @t datetime, @x int, @I int, @n datetime SELECT @prev=“SELECT @n=getdate( ) DECLARE thru CURSOR local forward_only FOR SELECT OpCaIndex, MIN(TiStartTime) AS Start, datediff (ss, MIN(TiStartTime), MAX (CASE WHEN TiFinishTime IS NULL THEN @n ELSE TiFinishTime END)) AS diff, TiCase AS tag FROM TimedOperations, AllowedOperations, Allowed Users WHERE TiOpIndex=OpIndex AND (NOT(TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) GROUP BY TiCase, OpCaIndex ORDER BY Tag, Start OPEN thru FETCH next FROM thru INTO @label, @t, @I, @tg WHILE @@fetch_status<>−1 BEGIN IF @tg<>@prev BEGIN SELECT @prev=@tg SELECT @first=@t END SELECT @x=datediff (ss, @first, @t) INSERT #res VALUES (@label, @x, @I) FETCH next FROM thru INTO @label, @t, @I, @tg END CLOSE thru SELECT label, AVG(x) AS x1, AVG(x+1) AS x2,COUNT(x) AS number FROM #res GROUP BY label ORDER BY x1DROP TABLE #res

CREATE PROCEDURE Sy_VAW_Ca_Gr

@UserIndex int, @GroupIndex int, @Case varchar(20), @OperationIndex int, @CategoryIndex int, @FromDate datetime, @ToDate datetime, @Live int AS SET NOCOUNT ON CREATE TABLE #res(series int, label int, X int, L int) DECLARE @tg varchar(30), @first datetime, @prev varchar(30), @label int, @t datetime, @x int, @I int, @n datetime, @series int SELECT @prev=” SELECT @n=getdate( ) DECLARE thru CURSOR local forward_only FOR SELECT OpCaIndex, MIN(TiStartTime) AS Start, datediff(ss, MIN(TiStartTime), MAX(CASE WHEN TiFinishTime IS NULL THEN @n ELSE TiFinishTime END)) AS diff, TiCase AS tag, UsGrIndex AS series FROM TimedOperations, AllowedOperations, AllowedUsers WHERE TiOpIndex=OpIndex AND (NOT (TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) GROUP BY TiCase, OpCaIndex, UsGrIndex ORDER BY Tag, Start OPEN thru FETCH next FROM thru INTO @label, @t, @I, @tg, @series WHILE @@fetch_status<>−1 BEGIN IF @tg<>@prev BEGIN SELECT @prev=@tg SELECT @first=@t END SELECT @x=datediff(ss, @first, @t) INSERT #res VALUES (@series, @label, @x, @I) FETCH next FROM thru INTO @label, @t, @I, @tg, @series END CLOSE thru SELECT series, label, AVG(x) AS x1, AVG(x+1) AS x2, COUNT(x) AS number FROM #res GROUP BY series, label ORDER BY series, label DROP TABLE #res

CREATE PROCEDURE Sy_VAW_Ca_Us

@UserIndex int, @GroupIndex int, @Case varchar(20), @OperationIndex int, @CategoryIndex int, @FromDate datetime, @ToDate datetime, @Live int AS SET NOCOUNT ON CREATE TABLE #res (series int, label int, X int, L int) DECLARE @tg varchar(30), @first datetime, @prev varchar(30), @label int, @t datetime, @x int, @l int, @n datetime, @series int SELECT @prev=“SELECT @n=getdate( ) DECLARE thru CURSOR local forward_only FOR SELECT OpCaIndex, MIN(TiStartTime) AS Start, datediff (ss, MIN(TiStartTime), MAX (CASE WHEN TiFinishTime IS NULL THEN @n ELSE TiFinishTime END)) AS diff, TiCase AS tag, UsIndex AS series FROM TimedOperations, AllowedOperations, Allowed Users WHERE TiOpIndex=OpIndex AND (NOT(TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) GROUP BY TiCase, OpCaIndex, UsIndex ORDER BY Tag, Start OPEN thru FETCH next FROM thru INTO @label, @t, @I, @tg, @series WHILE @@fetch_status<>−1 BEGIN IF @tg<>@prev BEGIN SELECT @prev=@tg SELECT @first=@t END SELECT @x=datediff (ss, @first, @t) INSERT #res VALUES (@series, @label, @x, @I) FETCH next FROM thru INTO @label, @t, @I, @tg, @series END CLOSE thru SELECT series, label, AVG(x) AS x1, AVG(x+I) AS x2,COUNT(x) AS number FROM #res GROUP BY series, label ORDER BY series, label DROP TABLE #res

CREATE PROCEDURE Sy_YAW_Op

@UserIndex int, @groupIndex int, @Case varchar(20), @OperationIndex int, @CategoryIndex int, FromDate datetime, @ToDate datetime, @Live int AS SET NOCOUNT ON CREATE TABLE #res (label int, x int, I int) DECLARE @tg varchar(30), @first datetime, @prev varchar(30), @label int, @t datetime, @x int, @I int, @n datetime SELECT @prev=” SELECT @n=getdate( ) DECLARE thru CURSOR local forward only FOR SELECT OpIndex, TiStartTime, CASE WHEN TiFinishTime IS NULL THEN datediff (ss, TiStartTime, @n) ELSE datediff (ss, TiStartTime, TiFinishTime) END AS diff, TiCase AS tag FROM TimedOperations, AllowedOperations, Allowed Users WHERE TiOpIndex=OpIndex AND NOT (TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) ORDER BY Tag, TiStartTime OPEN thru FETCH next FROM thru INTO @label, @t, @I, @tg WHILE @@fetch_status<>−1 BEGIN IF @tg<>@prev BEGIN SELECT @prev=@tg SELECT @first=@t END SELECT @x=datediff (ss, @first, @t) INSERT #res VALUES (@label, @x, @I) FETCH next FROM thru INTO @label, @t, @I, @tg END CLOSE thru SELECT label, AVG(x) AS x1, AVG(x+I) AS x2, COUNT(x) AS number FROM #res GROUP BY label ORDER BY x1 DROP TABLE #res

CREATE PROCEDURE Sy_VAW_Op_Gr

@UserIndex int, @groupIndex int, @Case varchar(20), @OperationIndex int, @CategoryIndex int, @FromDate datetime, @ToDate datetime, @Live int AS SET NOCOUNT ON CREATE TABLE #res (series int, label int, X int, L int) DECLARE @tg varchar(30), @first datetime, @prev varchar(30), @label int, @t datetime, @x int, @l int, @n datetime, @series int SELECT @prev=“SELECT @n=getdate( ) DECLARE thru CURSOR local forward_only FOR SELECT OpIndex, TiStartTime, CASE WHEN TiFinishTime IS NULL THEN datediff (ss, TiStartTime, @n) ELSE datediff (ss, TiStartTime , TiFinishTime) END AS diff, TiCase AS tag, UsGrIndex AS series FROM TimedOperations, AllowedOperations, AllowedUsers WHERE TiOpIndex=OpIndex AND (NOT(TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) ORDER BY Tag, TiStartTime, UsGrIndex OPEN thru FETCH next FROM thru INTO @label, @t, @I, @tg, @series WHILE @@fetch_status<>−1 BEGIN IF @tg<>@prev BEGIN SELECT @prev=@tg SELECT @first=@t END SELECT @x=datediff (ss, @first, @t) INSERT #res VALUES (@series, @label, @x, @I) FETCH next FROM thru INTO @label, @t, @I, @tg, @series END CLOSE thru SELECT series, label, AVG(x) AS x1, AVG(x+I) AS x2,COUNT(x) AS number FROM #res GROUP BY series, label ORDER BY series, label DROP TABLE #res

CREATE PROCEDURE Sy_VAW_Op_Us

@UserIndex int, @groupIndex int, @Case varchar(20), @OperationIndex int, @CategoryIndex int, @FromDate datetime, @ToDate datetime, @Live int AS SET NOCOUNT ON CREATE TABLE #res (series int, label int, X int, L int) DECLARE @tg varchar(30), @first datetime, @prev varchar(30), @label int, @t datetime, @x int, @I int, @n datetime, @series int SELECT @prev=” SELECT @n=getdate( ) DECLARE thru CURSOR local forward_only FOR SELECT OpIndex, TiStartTime, CASE WHEN TiFinishTime IS NULL THEN datediff (ss, TiStartTime, @n) ELSE datediff (ss, TiStartTime, TiFinishTime) END AS diff, TiCase AS tag, UsIndex AS series FROM TimedOperations, AllowedOperations, AllowedUsers WHERE TiOpIndex=OpIndex AND (NOT(TiFinishTime IS NULL) OR @Live=1) AND TiUsIndex=UsIndex AND NOT (TiCase IS NULL) AND (UsIndex=@UserIndex OR @UserIndex IS NULL) AND (UsGrIndex=@GroupIndex OR @GroupIndex IS NULL) AND (OpIndex=@OperationIndex OR @OperationIndex IS NULL) AND (OpCaIndex=@CategoryIndex OR @CategoryIndex IS NULL) AND (TiCase=@Case OR @Case IS NULL) AND (TiStartTime>=@FromDate OR @FromDate IS NULL) AND (TiStartTime<=@ToDate OR @ToDate IS NULL) ORDER BY Tag, TiStartTime, UsIndex OPEN thru FETCH next FROM thru INTO @label, @t, @I, @tg, @series WHILE @@fetch_status<>−1 BEGIN IF @tg<>@prev BEGIN SELECT @prev=@tg SELECT @first=@t END SELECT @x=datediff (ss, @first, @t) INSERT #res VALUES (@series, @label, @x, @I) FETCH next FROM thru INTO @label, @t, @I, @tg, @series END CLOSE thru SELECT series, label, AVG(x) AS x1, AVG(x+I) AS x2,COUNT(x) AS number FROM #res GROUP BY series, label ORDER BY series, label DROP TABLE #res

CREATE PROCEDURE Sy_YAW_Us

@UserIndex int, @Date datetime AS SET NOCOUNT ON CREATE TABLE #res (label int, x int, I int) DECLARE @tc varchar(20) DECLARE @tg varchar(30), @first datetime, @prev varchar(30), @label int, @t datetime, @x int, @I int, @n datetime IF @Date is null SELECT @Date=@n SELECT @prev=“ SELECT @n=getdate( ) SELECT @tc=TiCase FROM TimedOperations WHERE (TiCase IS NOT NULL) AND (TiPaused is NULL) AND (TiUsIndex=@UserIndex OR @UserIndex IS NULL) AND (TiStartTime<=@Date) AND (TiFinishTime>=@Date OR (TiFinishTime IS NULL and DATEDIFF (hh, TiStartTime, @Date)<12)) DECLARE thru CURSOR local forward_only FOR SELECT TiOpIndex, TiStartTime, CASE WHEN TiFinishTime IS NULL THEN datediff (ss, TiStartTime, @n) ELSE datediff (ss, TiStartTime, TiFinishTime) END AS diff, TiCase AS tag FROM TimedOperations WHERE TiCase=@tc ORDER BY Tag, TiStartTime OPEN thru FETCH next FROM thru INTO @label, @t, @I, @tg WHILE @@fetch_status<>−1 BEGIN IF @tg<>@prev BEGIN SELECT @prev=@tg SELECT @first=@t END SELECT @x=datediff (ss, @first, @t) INSERT #res VALUES (@label, @x, @I) FETCH next FROM thru INTO @label, @t, @I, @tg END CLOSE thru SELECT label, AVG(x) AS x1, AVG(x+I) AS x2, COUNT(x) AS number FROM #res GROUP BY label ORDER BY x1 DROP TABLE #res

1. A method for processing user resources, comprising the steps of:
receiving the said user resources on a user multi-platform computer system;
monitoring the workflow;
automatically analyzing the processing of said resources to gather information, measure the results and respond to the workflow; and
outputting decision-support data.

2. A method according to claim 1, and further comprising producing real-time workflow processing screens.

3. A method according to claim 1, wherein the information gathered is for the purpose of labor studies.

4. A method according to claim 1, wherein the information gathered is for the purpose of operation research.

5. A method according to claim 1, wherein the said gathering of information, measuring of the results and responding to the workflow utilizes tools available within the said user system.

6. A method according to claim 1, wherein the said gathering of information, measuring of the results and responding to the workflow permits the implementation of analysis add-on packages and interfaces.

7. A method according to claim 1, wherein the said results include workflow records.

8. A method according to claim 1, wherein the said results include processed displays.

9. A method according to claim 1, wherein the said method is integratable with the said user system.

10. Apparatus for processing user resources residing on a multi-platform system, which product comprises:
a system server to provide access to the required information;
a system database for the storage of the said information required for the said system;
a system administrator to edit information required for the operation of the said system; and
a system consultant for advanced analysis of historical data.

11. Apparatus according to claim 10, wherein the said database interfaces with QPI.

12. Apparatus according to claim 10, wherein the said edited information comprises workflow parameters.

13. Apparatus according to claim 10, wherein the said edited information comprises identification of users.

14. Apparatus according to claim 10, wherein the said edited information comprises security data.

15. Apparatus according to claim 10, and further comprising a system supervisor for producing real-time workflow monitoring screens.

16. Apparatus according to claim 10, and further comprising a system reactor for defining and activating alert and response rules.

17. Apparatus according to claim 10, and further comprising a system executive for creating and distributing analysis reports.
